(19) United States
(12) Patent Application Publication
(10) Pub. No.: US 2025/0068129 A1
(43) Pub. Date: Feb. 27, 2025

(54) WEARABLE LUMINOUS DISPLAY SYSTEM FOR DISPLAYING INFORMATION ORIGINATING FROM A MECHANICAL SOURCE

(71) Applicant: PRECIFLEX SA, Neuchätel (CH)

(72) Inventors: Johann Rohner, Pomy (CH); Jean Gubelmann, Yverdon-les-Bains (CH); Alain Jaccard, Sainte-Croix (CH); Luc Maffli, Fribourg (CH); Toralf Bork, Enges (CH); Mathieu Oulevey, Lausanne (CH)

(73) Assignee: PRECIFLEX SA, Neuchätel (CH)

(21) Appl. No.: 18/198,305

(22) PCT Filed: Nov. 19, 2021
(86) PCT No.: PCT/IB2021/060759

§ 371 Date: May 17, 2023

Related U.S. Application Data
(60) Provisional application No. 63/115,628, filed on Nov. 19, 2020.
(60) Provisional application No. 63/226,330, filed on Jul. 28, 2021.

(51) Int. Cl. G04B 45/00; G04B 19/24; G04B 19/26; G04B 47/04; G04C 10/00; G04C 19/02

(52) U.S. Cl. CPC G04B 45/0007; G04B 19/24; G04B 19/262; G04B 19/268; G04B 45/0038; G04B 47/04; G04C 10/00; G04C 19/02

(57) ABSTRACT

A display system is provided, configured to be integrated in an accessory to be worn by a wearer/user as an article of clothing, an item of jewelry, a wristwatch, a pocket watch or any other fashion item. The display system includes: (a) a source of electrical energy, (b) one or more light sources, (e) a source of mechanical information, visual animation or visual presentation, (d) a transformation device for transforming such information or visual animation into a luminous information or visual animation, and (e) a control device adapted to allow the user/wearer to control the activation of the system. In this manner, the system is able to provide a luminous information, visual animation or visual presentation.

### CROSS REFERENCE TO RELATED APPLICATIONS

This application is a PCT application claiming the benefit of U.S. Provisional Application No. 63/115,628, filed Nov. 19, 2020, and International Application No. PCT/IB2021/050723, filed Jan. 29, 2020, which claims benefit to U.S. Provisional Application No. 63/226,330, filed Jul. 28, 2021, the contents of the entirety of which are explicitly incorporated herein by reference and relied upon to define features for which protection may be sought hereby as it is believed that the entirety thereof contributes to solving the technical problem underlying the invention, some features that may be mentioned hereunder being of particular importance.

### IDENTIFICATION OF PARTIES CONCERNED

The Applicant of the present intellectual property matter is Preciflex SA of Switzerland. The inventors of the invention described in this patent documentation are Johann ROHNER, Jean GUBELMANN, Alain JACCARD, Luc MAFFLI, Toralf BORK and Mathieu OULEVEY. At the time of filing, John B. MOETTELI and the firm Da Vinci Partners LLC of Switzerland represent the Applicant.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

The invention relates to the field of wearable displays including a mechanical source of information or visual animation and a luminous representation of such information or visual animation, such displays being integrated in carried or worn accessories like watches, jewelry, necklaces, pendants, hats, shoes, handbags, belts etc. Traditionally such information or visual animation is either generated by a mechanical source and displayed by mechanical means, or generated by electronic means and displayed by mechanical means or luminous means or electronically modulated optical devices (such as liquid crystal displays). Sometimes the mechanical display means are covered with light-emitting paints or decorations, but such light-emitting paints or decorations only last for a certain duration after having been exposed to ambient light, and their light-emitting functionality cannot be controlled by the user/wearer. In the field of high value accessories, an electronic controlled display is often perceived as low-end product.

The invention is a device for transforming mechanically generated information, a visual presentation or visual animation into a luminous information or luminous visual animation without using a permanently powered electronic device, preferably without using any electronic logic device, even more preferably, without using any electronic device, and in a manner that can be controlled by the user/wearer.

### SUMMARY OF THE INVENTION

A display system is provided, configured to be integrated in an accessory to be worn by a wearer/user as an article of clothing, an item of jewelry, a wristwatch, a pocket watch or any other fashion item. The display system includes: (a) a source of electrical energy, (b) one or more light sources, (c) a source of mechanical information, visual animation or visual presentation, (d) a transformation device for transforming such information or visual animation into a luminous information or visual animation, and (e) a control device adapted to allow the user/wearer to control the actuation/activation of the system. In this manner, the system is able to provide luminous information, a visual animation or visual presentation.

### BRIEF DESCRIPTION OF THE DRAWINGS

The attached drawings represent, by way of example, different embodiments of the subject of the invention.

FIG. 1 is a schematic view of the luminous display of the present invention.

FIGS. 2A to 2C are schematic views of the transformation means.

FIG. 3 is perspective view of an alternative transformation means including ITO conductive tracks.

FIG. 4A is a side view of another alternative transformation means including a flexible bent beam to contact.

FIG. 4B is a top view of the alternative transformation means of FIG. 4A.

FIGS. 5A and 5B are schematic views of alternative embodiments of the transformation device of the invention.

FIG. 6 is a perspective view of an alternative embodiment of the transformation device of the invention.

FIGS. 7A and 7B are perspective views of another alternative transformation means including gears and/or a mechanical collector switch.

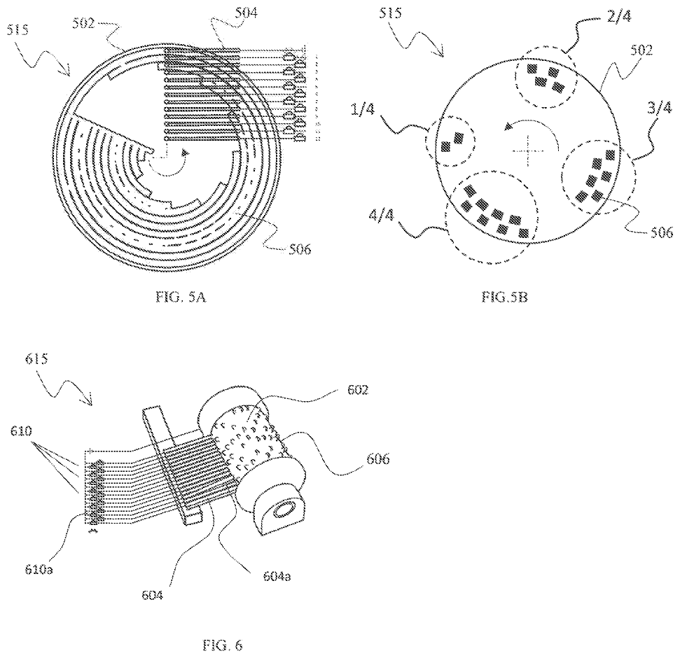

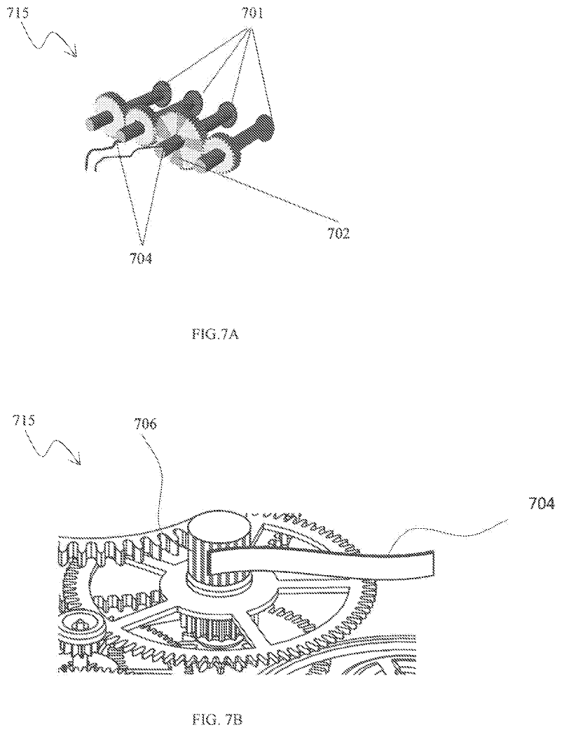

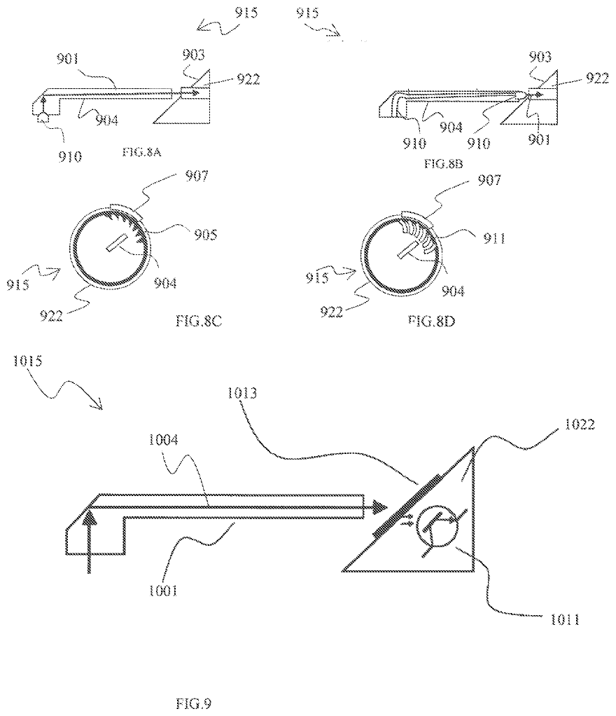

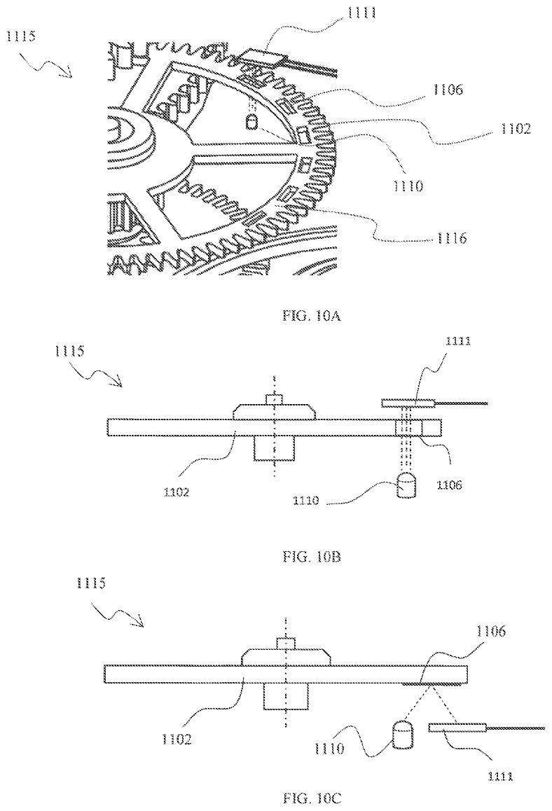

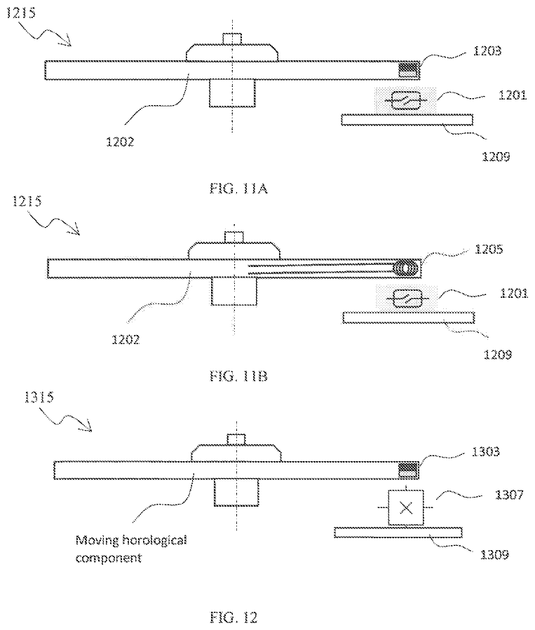

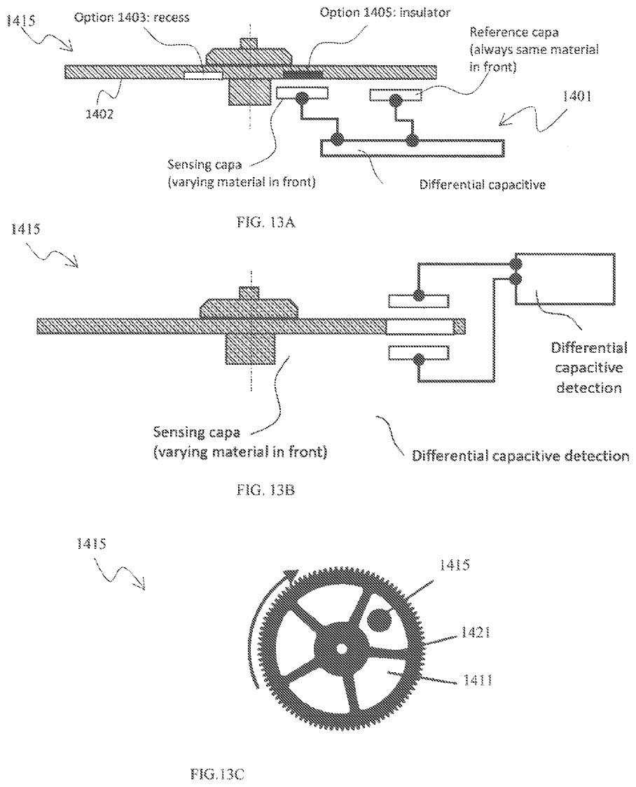

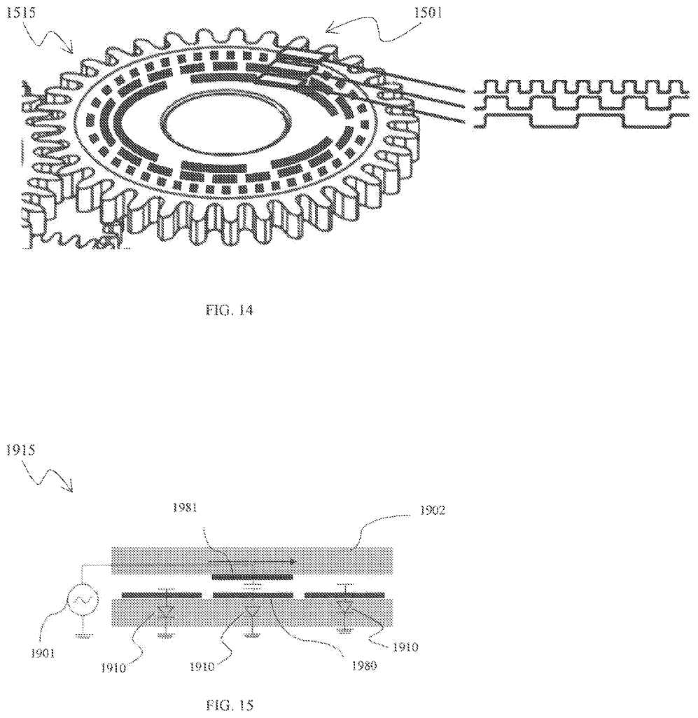

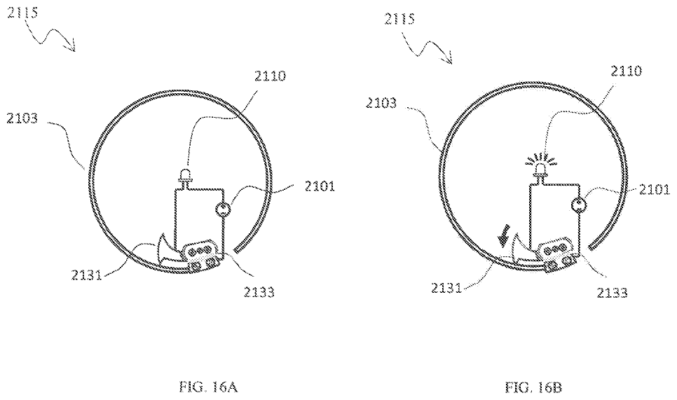

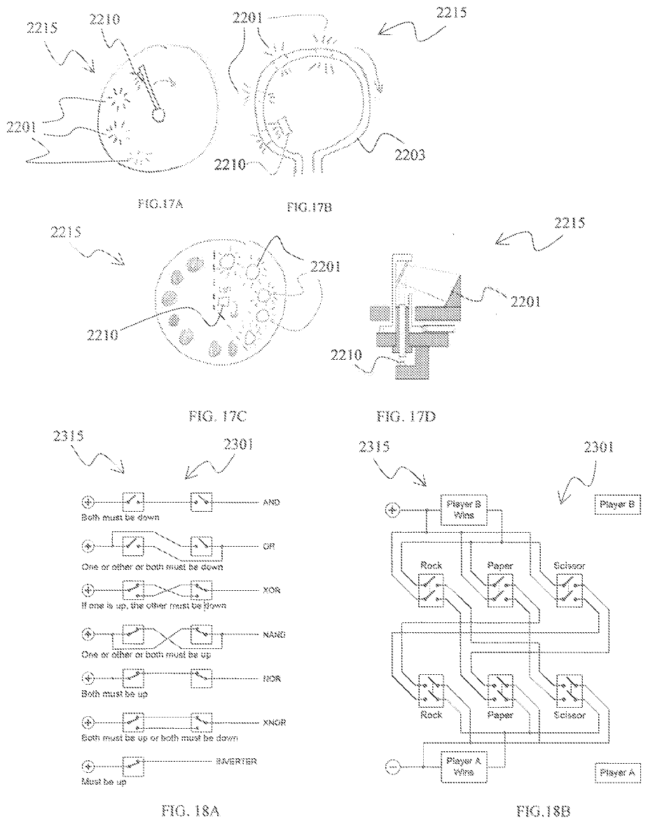

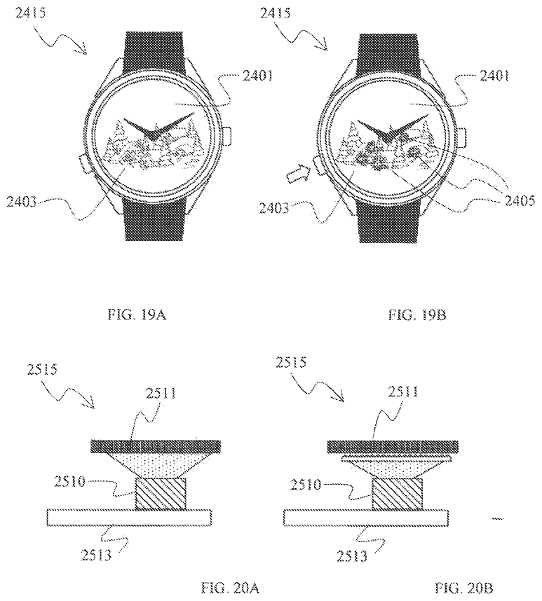

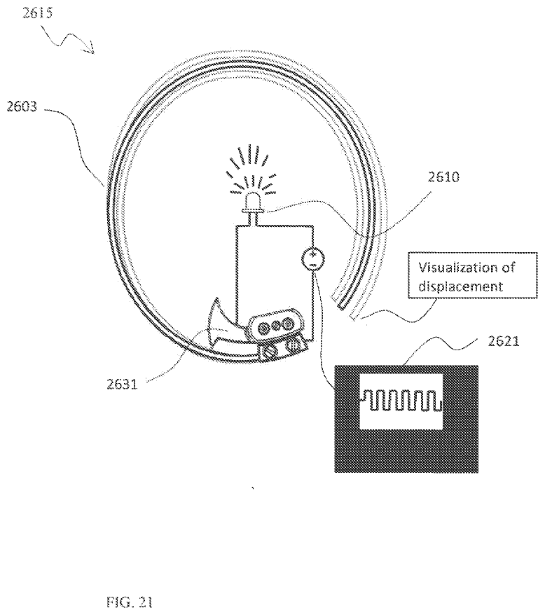

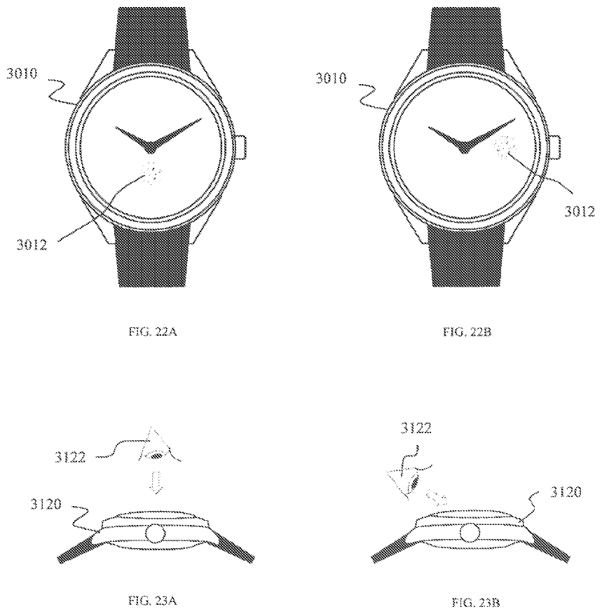

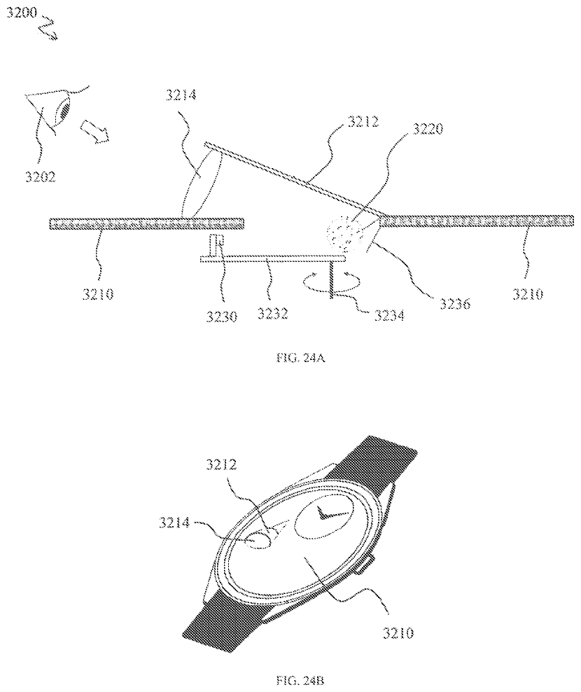

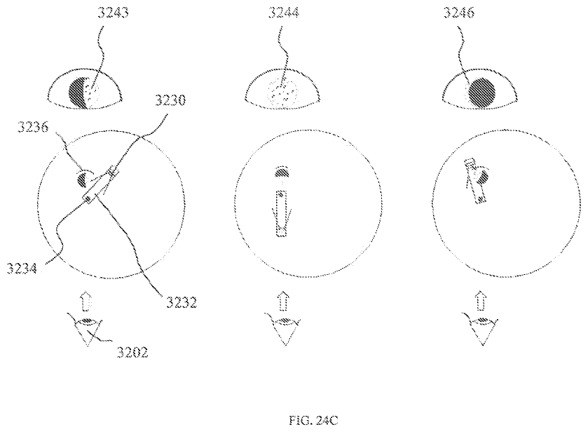

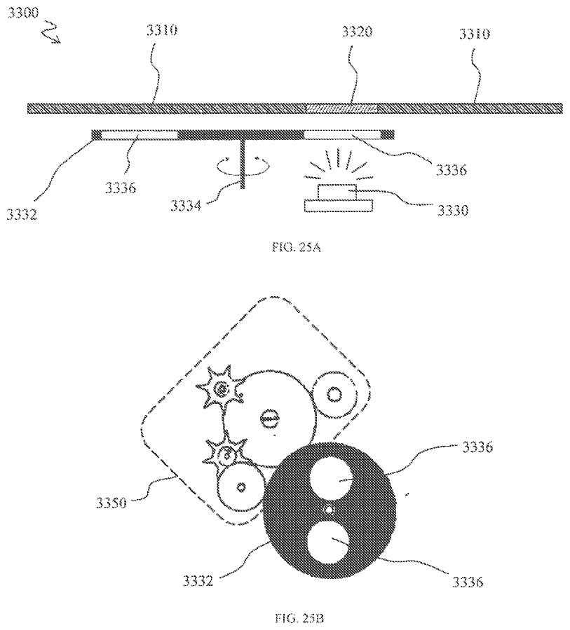

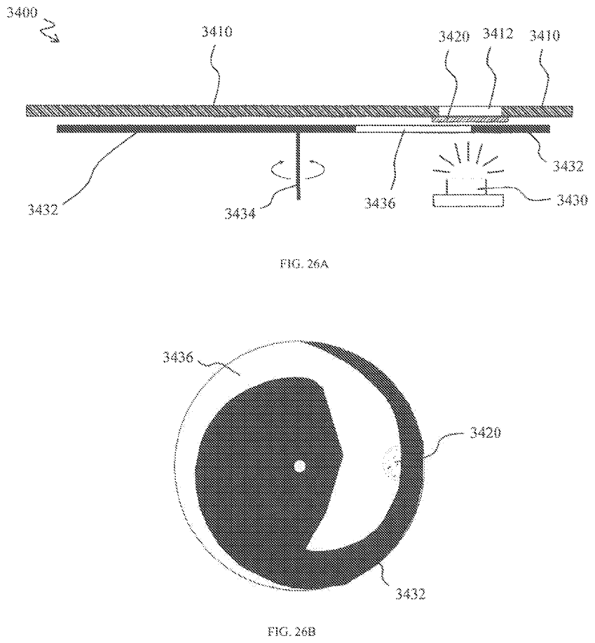

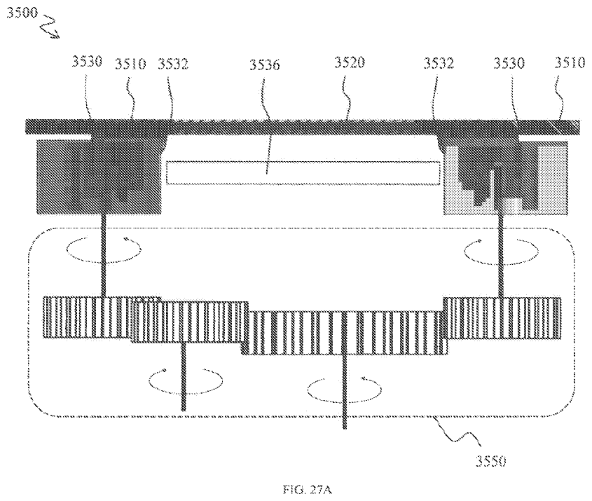

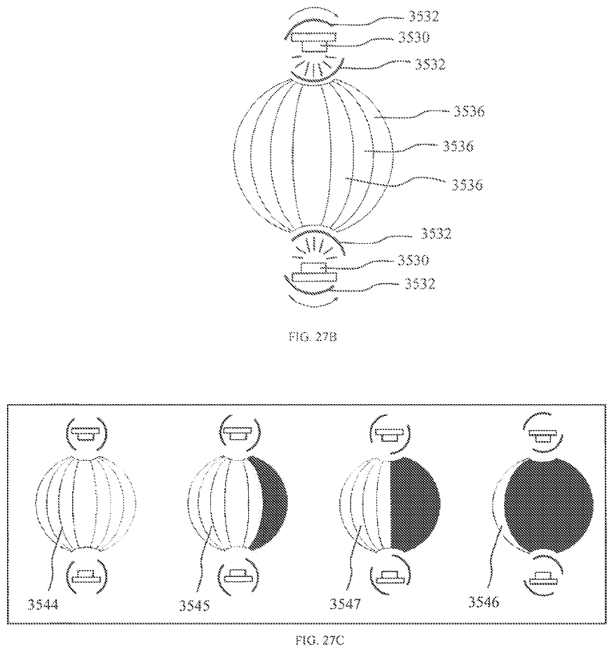

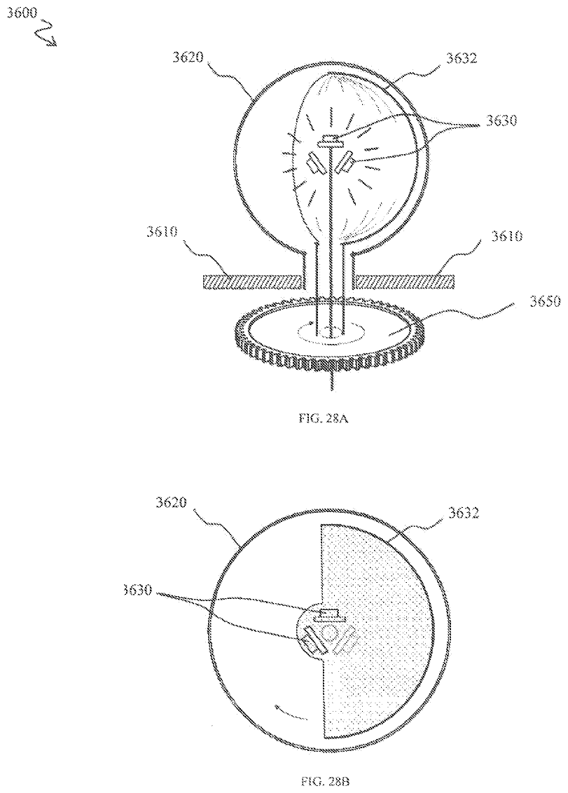

FIG. 5A to 5D are schematical views of another alternative transformation means including a mechanism that moves a mobile element such as an hour hand.

FIG. 9 is a schematical view of another alternative transformation means including a phototransistor or photodiode array.

FIGS. 10A to 10C are schematic views of another alternative transformation means including an optical sensor.

FIGS. 11A and 11B are schematic views of another alternative transformation means including a reed relay.

FIG. 12 is a schematical view of still another alternative transformation means including a Hall effect sensor array.

FIGS. 13A to 13C are schematic views of another alternative transformation means including a capacitive sensor.

FIG. 14 is a perspective view of another alternative transformation means including an absolute position sensing with an encoding with several sensors.

FIG. 15 is a schematic view of another alternative transformation means including at least one capacitor switch.

FIGS. 16A and 16B are schematic views of another alternative transformation means including an electrical connection to a hammer of a traditional ringing mechanism.

FIGS. 17A to 17D are schematic views of another alternative transformation means including a LED.

FIGS. 18A and 18B are schematic views of another alternative transformation means including electrical logic.

FIGS. 19A and 19B are schematic views of another alternative transformation means including at least one transparent or semi-transparent window.

FIG. 20A to 20B are schematic views of another alternative transformation means including laser-drilled pinholes.

FIG. 21 is a schematic view of another alternative transformation means including a LED lightning.

FIGS. 22A and 22B are top views of examples of integration of the system of the invention in a wristwatch.

FIGS. 23A and 23B are side views showing examples of angles of viewing the system of the invention in a wristwatch.

FIG. 24A is a schematic side view of an embodiment of the invention.

FIG. 24B is a perspective view of the above embodiment of the invention.

FIG. 24C is a top view of the above embodiment of the invention and the resulting display in three different positions.

FIG. 25A is a cross-sectional side view of another embodiment of the invention.

FIG. 25B is a partial top view of the above embodiment of the invention.

FIG. 26A is a cross-sectional side view of a still further embodiment of the invention.

FIG. 26B is a partial top view of the above embodiment of the invention.

FIG. 27A is a cross-sectional side view of an alternate embodiment of the invention.

FIG. 27B is a partial top view of the above embodiment of the invention.

FIG. 27C is a schematic view of display results of the above embodiment of the invention.

FIG. 28A is a partial sectional view of a second alternate embodiment of the invention.

FIG. 28B is a cross-sectional top view of the above embodiment of the invention.

FIG. 28C is a view of the display result of the above embodiment of the invention.

FIG. 29A is a partial sectional view of a third alternate embodiment of the invention.

FIG. 29B is 4 cross-sectional side views of the above embodiment of the invention in 4 different positions.

FIG. 30A is a general view of a wristwatch using a further two alternate embodiments of a display according the invention when the display is not activated.

FIG. 30B is the general view of the wristwatch of FIG. 30A when the display is activated.

FIG. 30C is a cross-sectional view of the embodiment of FIG. 30A.

FIG. 30D is a cross-sectional view of the another embodiment of the system of the invention.

FIG. 30E is an exploded view of the mechanism of the above two embodiments of the system of the invention when the display is not activated.

FIG. 30F is the exploded view of FIG. 30E when the display is activated.

FIG. 31A is a plan view of a wristwatch using yet another two embodiments of a display according the invention when the display is not activated.

FIG. 31B is the plan view of the wristwatch of FIG. 31A when the display is activated and displays an information/animation.

FIG. 31C is the plan view of FIG. 31A when the display is activated and displays another information/animation.

FIG. 31D is a cross-sectional view of the penultimate embodiment of the system of the invention.

FIG. 31E is a cross-sectional view of the embodiment following the penultimate embodiment of the invention.

FIG. 32A is a plan view of a wristwatch using a further embodiment of a display according the invention when the display is not activated.

FIGS. 32B to 32E are plan views of the wristwatch of FIG. 32A when the display is activated and shows different information or animations.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

The present invention relates to the field of wearable displays including a mechanical source of information or visual animation and a luminous representation of such information or visual animation, such displays being integrated in carried or worn accessories like watches, jewelry, necklaces, pendants, hats, shoes, handbags, belts etc. Traditionally such information or visual animation is either generated by a mechanical source and displayed by mechanical means (mechanical watch), or generated by electronic means and displayed by mechanical means (quartz watch), luminous means (LED/OLED displays) or electronically modulated optical devices (such as liquid crystal displays). An usual mechanical means to generate an information or visual animation can be a clock movement, an automaton, an action of the user/wearer pushing a button, actuating a lever, turning a crown or a crank, a moving mass actuated by the combination of gravity and a movement of the device's wearer or a magnetic field external to the device (e.g., geomagnetic field), directly or via a magnetic transmission. Displaying mechanical information or visual animation typically uses watch hands, panels, pallets, segmented symbols, displaced along or across indicia, or hidden and shown to display changing information or visual animation. Typical luminous means of displaying information or visual animation are pixelated electronic displays such as OLED screens, liquid crystal displays (LCD) equipped with active illumination function, selective switching of several LEDs arranged in arrays, segments or patterns, electroluminescent material activated by a local electric field, and optical modulations such as liquid crystal displays (LCD) using ambient light reflection. Sometimes the mechanical display device is covered with light-emitting paints or decorations, but such light-emitting paints or decorations only last for a certain duration after having been exposed to ambient light, and their light-emitting functionality cannot be controlled by the user/wearer. In the field of high value accessories, an electronically controlled display is often perceived as low-end product.

The invention is a device for transforming mechanically generated information or visual animation into a luminous information or luminous visual animation without using a permanently powered electronic device, preferably without using any electronic logic device, even more preferably without using any electronic device, and in a manner that can be controlled by the user/wearer.

The key components defining the display system of the present invention are:
a) a source of electrical energy,
b) one or more light sources receiving and transforming the electrical energy produced by the source of electrical energy (a) into light,
c) a mechanical source of information or visual animation,
d) a transforming device for transforming such information or visual animation into a luminous information or visual animation, and
e) means for the user/wearer to control the activation of the display system.

A source of electrical energy for the display system of the invention (a) can be any source of electrical energy selected from a list including a battery, an electrochemical device, a rechargeable battery, a solar cell, an electrical energy harvesting device, a miniature generator actuated by the user/wearer, or actuated by the combination of the movements of the user/wearer and the effect of gravity on a mobile mass. The source of electrical energy (a) may include means to store the energy in electrical form, in mechanical form, or in electrochemical form, and means to release this energy upon an action of the user/wearer, upon an action of source of mechanical information or visual animation, or upon a combination thereof.

A light source of the display system of the invention (b) can be any source of light selected from a list including a light bulb, a LEC (light-emitting capacitor), LED (light-emitting diode), an OLED (organic light-emitting diode), an AMOLED (active-matrix organic light-emitting diode), a laser, a laser diode, any electroluminescent material activated by a local electric field, any electroluminescent material activated by an electric current, or phosphorescent material, or any combination thereof. The light source of the display system of the invention (b) may produce light in any colour, and means to shift or filter the light frequency may be used. Means to shift or filter the light frequency can be any element including a fluorescent liquid or non-liquid material, quantum dots, or an optical filter film. The light source of the display system of the invention (b) may combine the production of an electromagnetic radiation outside of the visible light spectrum (e.g., UV, IR) and material that converts such radiation into visible light. A mechanical source of information, visual animation or visual presentation of the display system of the invention (c) can be any mechanical source of information or visual animation selected from a list including engraved disks/rolls/bands, graded disks/rolls/bands, perforated disks/rolls/bands, patterned disks/rolls/bands, patterned transparent/opaque segments on disks/rolls/bands, patterned conductive/non-conductive layers on disks/rolls/bands, conductive/non-conductive segments in wheels/disks/rolls/bands, cams and followers, levers, mechanical probes, keys, or any combination thereof. It should be emphasized that the information exists in a mechanical form, basically the position, the form, or the movement of a mechanical part at some location in a mechanism, and it is not something memorized on a microchip. This mechanical source of information may be driven purely mechanically, but may also be driven by an electrical motor, by the effect of gravity, etc. The mechanical source of information or visual information can be a moving component of a mechanism with no specific feature added to convey the information, whose position, speed, moving frequency or other type of mechanical information can be read by non-contact sensing means. The mechanical source of information or visual animation (c) may be activated continuously (such as a mechanical timepiece movement) or only when triggered by the user/wearer, it may contain a reserve of mechanical energy such as a spring, a spring-barrel, compressed fluids, or any other means to store mechanical energy well-known in the industry, and may be recharged by the user/wearer or by a mobile mass actuated by the combination of gravity and a movement of the device's wearer (e.g. self-winding mechanisms) independently from the functioning of the display system of the invention.

Means (d) to transform a mechanical information or visual animation (c) into a luminous information of the display system of the invention may work on the electric circuit that connects the source of electrical energy (a) with the light source (b), or between the light source (b) and the eye of the observer/user/wearer. Means (d) to transform mechanical information or visual animation into a luminous information of the display system of the invention working on the electric circuit that connects the source of electrical energy (a) with the light source (b) can be any means to connect, disconnect or modify the conductivity of an electrical circuit selected from a list including a contact collector, an electric switch, an inductive relay, a light sensitive electrical relay, an electrical potentiometer, a sensor connected to a control electronics, or any combination thereof. Means (d) to transform mechanical information or visual animation into a luminous information of the display system of the invention working between the light source (b) and the eye of the observer/user/wearer can be any means to interrupt, conduct or modulate light selected from a list including shutters, shades, filters, interference filters, polarizing filters, optical diffraction elements, mirrors, or any combination thereof.

Means (e) for the user/wearer to control the activation of the display system of the invention can be any means of interaction selected from a list including a lever, a push-button, a rotary button, a crown, a rotary crown, or any combination thereof. Means (e) for the user/wearer to control the activation of the display system of the invention may allow the user/wearer to directly trigger the displaying of the information or visual animation, to enable the displaying of the information or visual animation which is launched automatically by the source of mechanical information or visual animation (c), to recharge the source of mechanical information or visual animation (c), to recharge the source of electrical energy (a), or any combination thereof.

The luminous information or visual animation produced by the display system of the present invention can be any information or visual animation selected from a list including time-related information such as “repetition minute”, “date”, “grande date”, countdown, chronometer, moon phase, tides, alarm at a fixed time, time zones or similar, non-time-related information such as power reserve, ambient temperature, ambient pressure/altitude, orientation (compass), barometer, diving depth or similar, personalized user/wearer-related information, or from a list including visual animation such as star map, planetarium, binary random generation, animation of moveable or fixed decorative elements, emphasis of valuable decorative elements such as gems, visibility enhancement or emphasis of technical functions of the wearable device, revealing decorative element or technical functions of the wearable device that remain otherwise hidden or not illuminated, or any combination thereof.

The mechanical source of information can be taken from a list including hour wheel, minutes wheel, second wheel, center wheel, escape wheel, balance wheel, ratchet wheel, crown or any intermediate gear wheel as well as directly on complication moving part such as
moon phase indicator wheel
date indicator
day of the week indicator
day of the month indicator
striking mechanism (hours, quarters, minutes)
flywheel
chronograph mobile
oscillating weight
power reserve

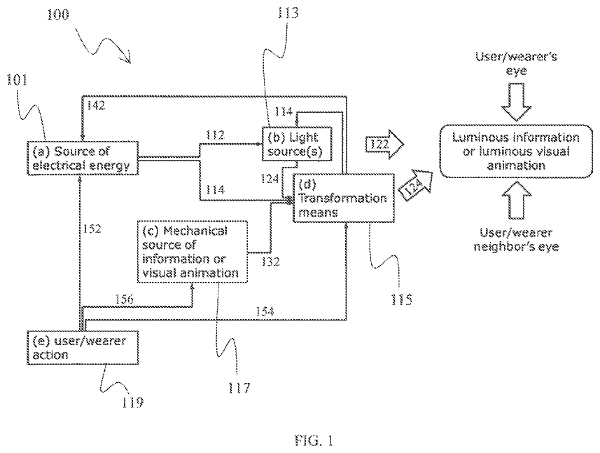

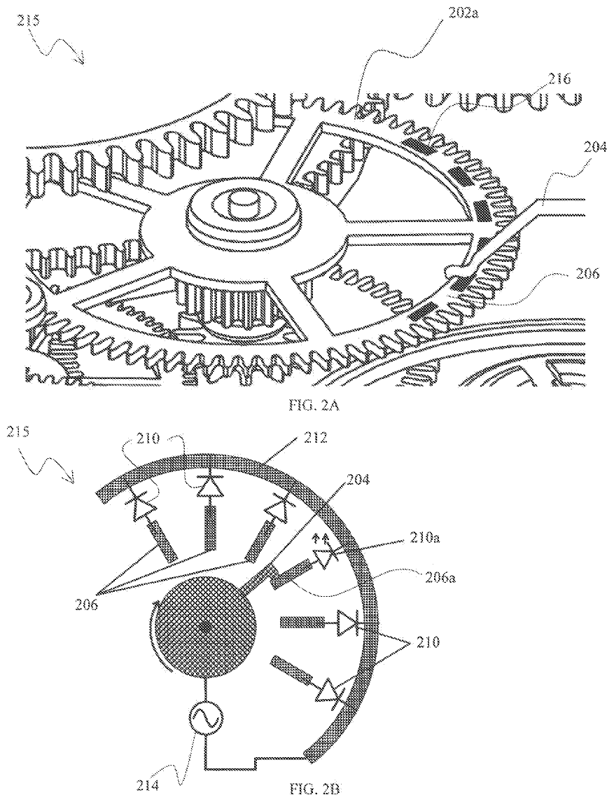

Referring now to FIG. 1, the luminous display of the invention 100 can have numerous embodiments. The source 101 of electrical energy feeds electrical energy to the one or more light sources 113 directly 112 or indirectly 114 via the transformation means 115. The one or more light sources 113 emit light which generates a luminous information or luminous visual animation that can be observed by the user/wearer and/or other people around the wearer/user, directly 122 or indirectly 124 through the transformation means 15. The information 132 or visual animation provided by the mechanical source 117 is converted into a luminous information or a luminous visual animation by the transformation means 115. The transformation means 115 can interact directly 114 with the one or more light sources 113, or indirectly 142 through the source of electrical energy 101. The user/wearer 119 can interact with the source of electrical energy 101 directly 152 or indirectly 154 through the transformation means 115. He can also interact directly 156 with the mechanical source of information 117, such possibility of action by the wearer/user to activate the display system is often also expressed as an “on-demand display”, but it does not necessarily imply that the luminous information or visual animation is made immediately after the user/wearer has made the “demand” (or enabled the system). It may also take place later, at a time defined by the mechanical source 117 or when the mechanical source 117 reaches a pre-determined configuration (for example: top of the hour, quarter of an hour, noon, . . . ). The activation of the system by the user/wearer may also last for a predefined duration, or for a number of occurrences. For example, in Paris, the Eiffel tower is illuminated for 5 minutes every hour during the night. Such functionality can be reproduced with the display system of the invention: the user/wearer activates the system, and then the mechanical source of information 117 provides the display lighting for 5 minute every hour, until the user/wearer disables the functionality or until a predefined time or a predefined number of occurrences is reached. As demonstrated by the following figures and the corresponding description, any combination of the above interactions can be used to constitute an embodiment of the display system of the invention 100.

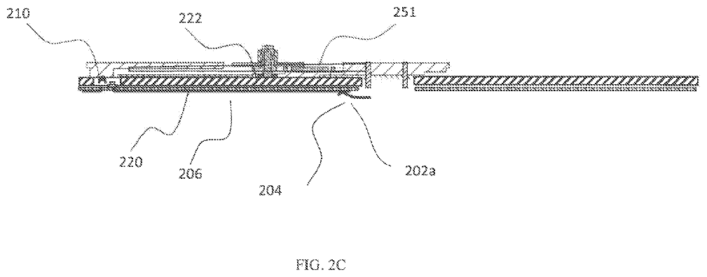

Referring now to FIGS. 2A to 2C, the transformation means 115, 215 includes a rotating wheel 202 which contains a moving electrical contact brush 204. The moving electrical contact brush 204 can be moved by the user/wearer action 119 or by the mechanical source of information 117 when activating/deactivating the system so as to activate/deactivate the transformation means 115, 215. Depending on the position of the rotating wheel 202, this moving electrical contact brush 204 can touch one of the individual contacts 206 made of copper tracks. The copper tracks may be fully or partially coated by one or more layers of metal and/or an insulating material. Those individual contacts 206 are connected to individual light sources 210 such as LEDs. All other terminals of the individual light sources 210 are connected to a common fixed contact 212 in form of a copper track. Upon activation, a source of electrical energy 214 applies an electrical potential between this common contact 206a and the moving contact 204 of the rotating wheel 202. In this manner, only the light source 210a that is interconnected to the moving contact 204 of the rotating wheel 202 will be activated and emit light, thereby conveying the mechanical information of the position of the rotating wheel 202 into luminous information.

In another advantage, the invention can use gold alloys, other conductive metals or indium tin oxide (ITO) for conducting the electrical signals. Gold alloys or other conductive metals can have the advantage of being perceived by the user as a decorative material of high value.

A brush connected to a wheel 202 connected to one of the poles of the energy source 214 creates the contact on one of the poles depending on the position of the wheel 202. An advantage is the simplicity of the principle.

Referring now to FIG. 2C, the contacts 206 are placed on the hour wheel 202a of the watch movement. The sequence of contacting 206 or insulating 216 portion allows to determine the scheme of illumination of one or more light source. The illumination is then synchronized with the time indication according to the position of the hour wheel 202a.

Referring now to the FIG. 2C, the contact brush 204 is fixed on the hour wheel 202a and the contact pads/tracks are on a PCB 220 under the dial 222. This configuration allows to activate independently light sources as a function of the position of the hour wheel 202a. For instance, one can illuminate the corresponding hour index on the dial 222 at the time where the hand 251 point on the index or one can have a totally different display with a light indicating the corresponding hour.

In another configuration the contacts 206 can be directly deposited on an insulating layer of the dial 222, thus reducing the need for an additional PCB.

The electrical contact described above with the hour wheel 202 can be similarly implemented on the minute wheel or any of the mobile wheel of the watch movement.

The electrical contact 206 can also be created by two conductive moving elements of the movement that are in contact only at specific moments (e.g., when the hammer hits the gong of a Grande sonnerie or minute repeater).

Referring now to FIG. 3, the transformation means 115, 315 includes ITO conductive tracks 306 that have the advantage of being transparent, and can therefore be made invisible to the user for decoration purposes. Based on the idea as described by means of FIGS. 2A to 2C, a gold or any conducting material blade with a geometry designed for its visual aspect creates a contact on invisible ITO tracks 306 allowing an aesthetic rendering and not connected to electrical components. One advantage is the wide range of design possibilities. By way of example, the IoT conductive tracks are applied on a surface 310 made of glass or sapphire. The surface 310 may be part of a wheel such as described for FIGS. 2A to 2C. The present embodiment includes a tapper 304, such as a contact brush which comprises conductive material.

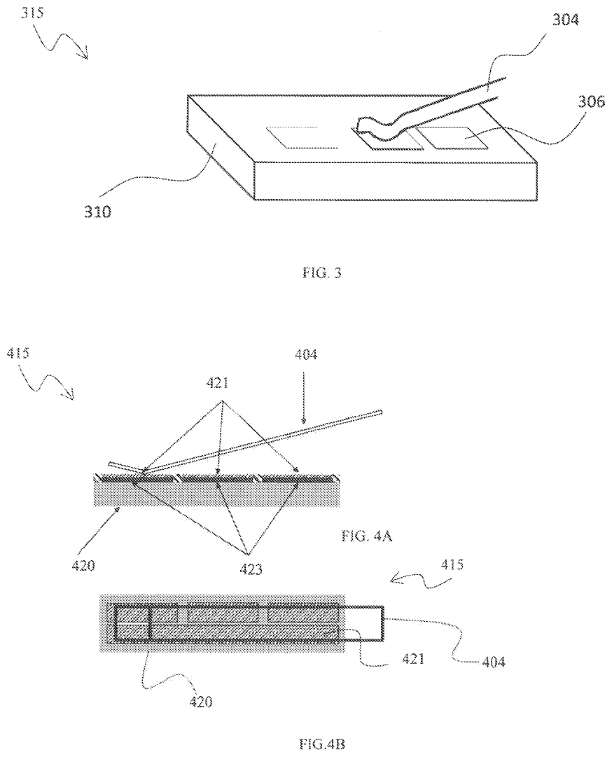

Referring now to FIGS. 4A and 4B, the transformation means 115, 415 includes a flexible bended beam 404 to contact with very light pressure a PCB 420. The PCB 420 has a hard gold 421 treatment on copper pads 423 to stand the friction.

A fluid-repellent layer or coating may optionally be added to reduce the friction coefficient. The flexible bended beam 404 that are in movement and they might be wide enough to cover/contact the primary contact as well as the secondary contact all at once/at the same time. One advantage is that the system is compliant with alternative power supply from a generator.

Referring now to FIG. 5A and FIG. 5B, the transformation means 115, 515 includes a non-conductive rotating disc 502 with conductive tracks 506 adhered/deposited on the disc 502, the tracks 506 made out of conductive materials which are patterned concentrically. Each conductive track 506 can be continuous or interrupted. To generate a time-related information, the mechanical source of information 517 is a clock mechanism, and the rotating disc 502 is driven by the hour wheel, by the minute wheel, by the seconds wheel, by a chronograph mechanism, by a date mechanism, by a moon phase mechanism, by one of the wheels of a minute repeater mechanism, or by any other complication mechanism as known in the Horological industry. Same principle as for the music box, but the drum is replaced by a disc 502 with conductive tracks 506. The use is simple: the embodiment as shown in FIG. 5A comprises a disc 502, the disc 502 turns in sync with the hour wheel, a conductive track of adapted shape conducts the current in such a way as to light up one more light source 510 such as an LED at each hour.

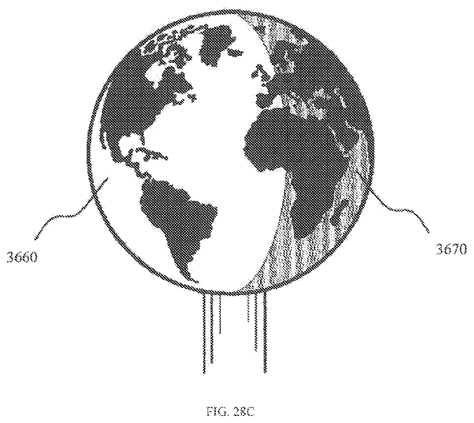

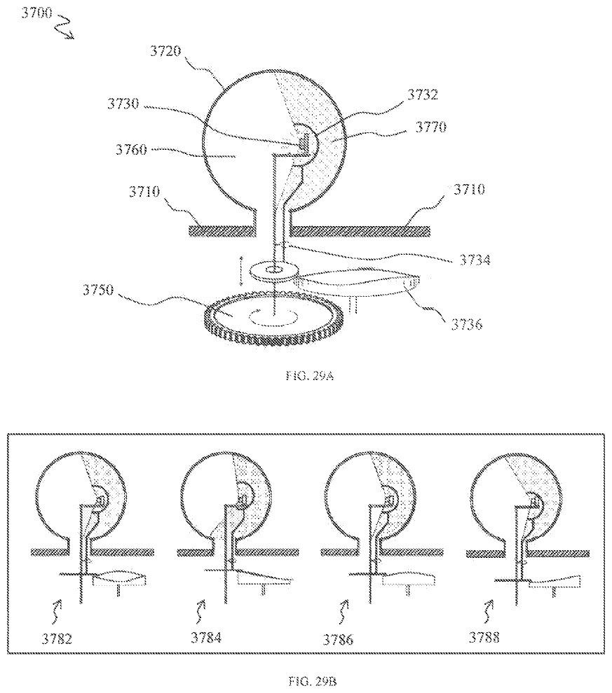

Referring now more specifically to FIG. 5B, to generate a visual animation, the transformation means 515 includes a rotating disc 502, the rotating disc 502 can make one or several turns upon activation by the user/wearer or by a clock mechanism at preset time intervals. 1o Conductive tracks 506 are patterned or deposited along concentric rings and provide a specific set of contact to sliding contacts for each angular position. There is one sliding contact 504 per track 506, so that any binary combination of ON/OFF states of the series of the mechanical contacts can be achieved. In another configuration, several sliding contacts 504 can be used on a same track. The electrical signal is composed of a binary combination of signals carried on several tracks 506, each having its own electrical potential relative to the ground. The electrical signal can be used directly to light a set of light sources 510, or be further processed by logic elements to produce another type of information on a reduced number of contacts 506. The embodiment in FIG. 5B shows the realization of a sequence of flashes. The sequences of quarter hours, may requires a multilayer conductor track. All kinds of sequences are possible, either synchronized with the movement (hour disc, quarter hour disc, minute disc), or launched only on-demand—any light show is possible. The advantages are: easy to customize sequences. Probably allows a flatter integration than the drum/barrel 602 described in FIG. 6.

Referring now to FIG. 6, the transformation means 115, 615 includes a rotating barrel 602 equipped with conductive spikes 606 that connect with blades 604a during a part of their rotation, producing an intermittent electrical contact. Contact is made, for example, by pins 606 such as in a music box. The spikes or pins 606 may be in contact with blades 604a or not in contact with blades 604, depending the position of the barrel 602. The device provides the possibility to synchronize sound and light. The use can be simple: the drum 602, for example, can be designed to make one turn per 24 hours. As alternatives, a sequence (melody and/or light show) is triggered, whereby several possible sequences (drum of the hours, drum of the quarters of hour, drum of the minutes, drum of noon) are possible. If only light is used, the “spikes” 606 can be longer to generate different lighting lengths or flashes, we could make a luminous Morse code. The advantages are: easy to customize sequences. Synchro sound/light possible. Light sources 610 may be activated 610a depending if a blade 604 is in contact with a spike or pin 606.

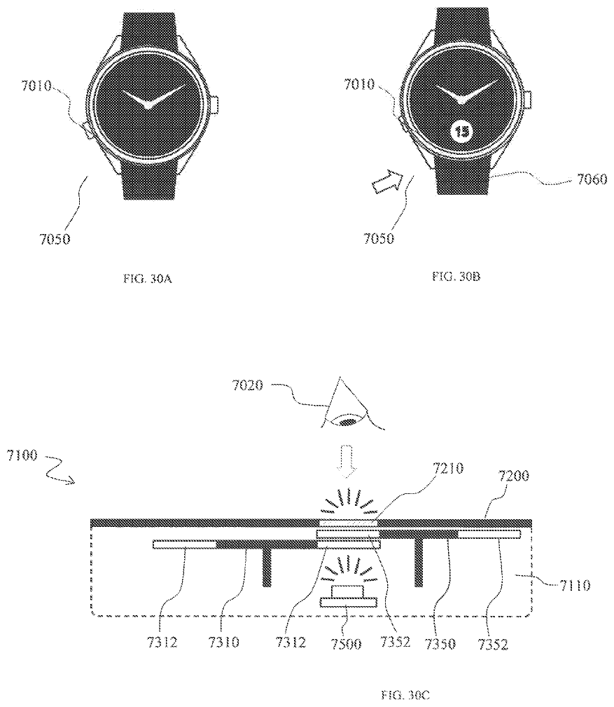

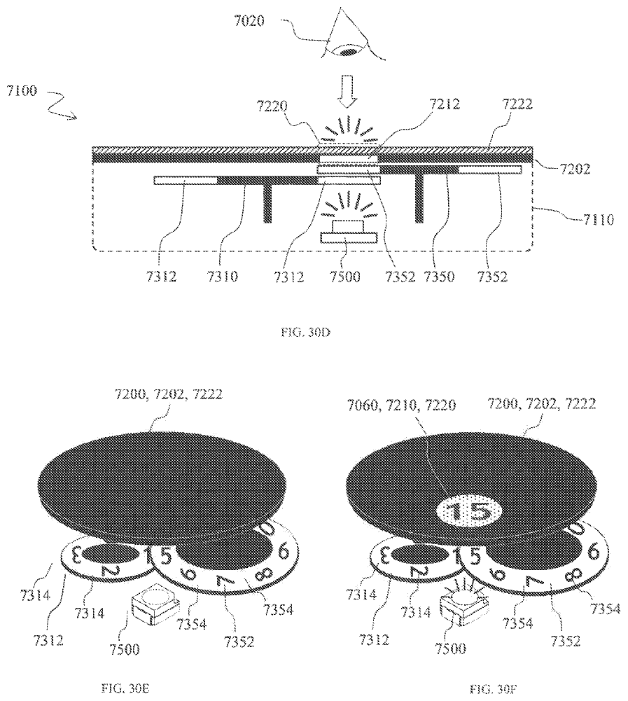

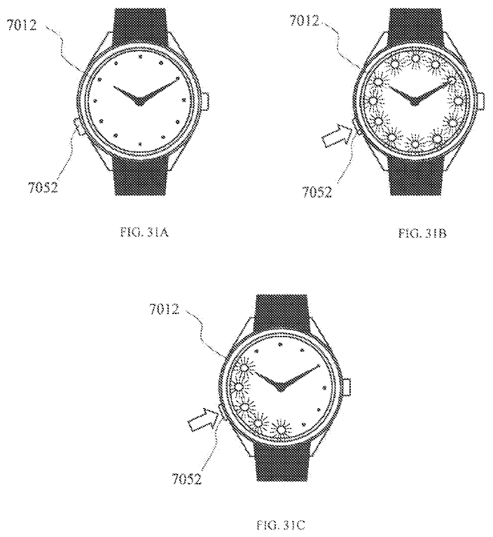

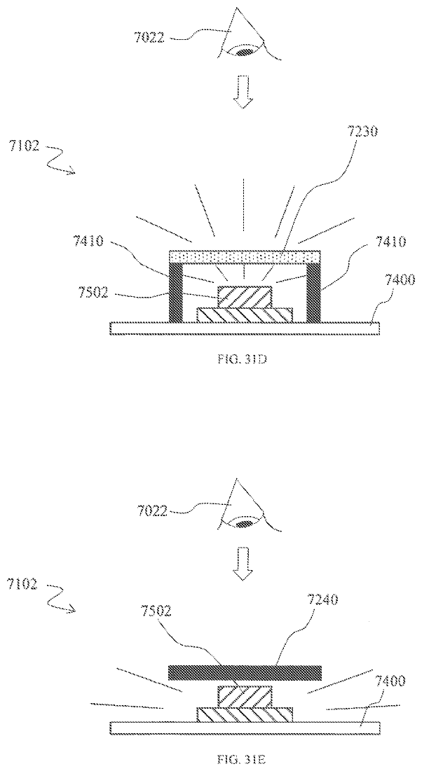

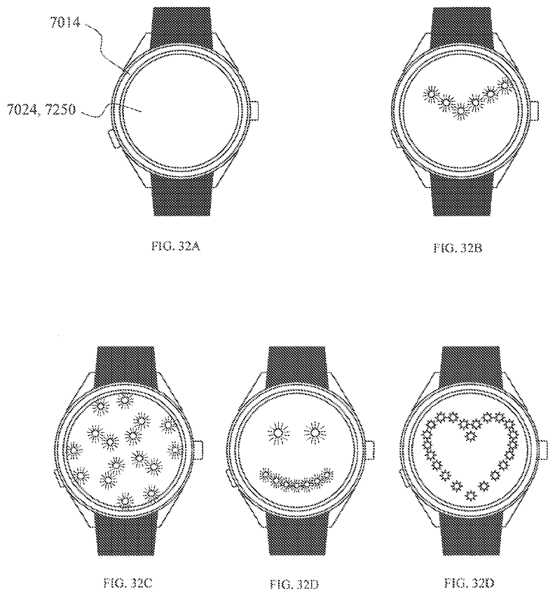

Referring now to FIG. 7A, the transformation means 115, 715 includes gear wheels, whereof at least one gear wheel 702 is made in part of conductive 706 and in part of non-conductive 716 material. As a result of their rotation, the gear wheels 702 producing an intermittent electrical contact between themselves. As an alternative, the surface of the gear teeth is made up of, in part, conductive 706 and, in part, non-conductive 716 material. A gear on the gear train has conductive 706/non-conductive 716 sectors. It is used as an angular position-dependent switch. The wheel 702 can be made of 2 different materials, of insulating coating 716 on selected parts of wheels 702, or of silicone with highly doped 706 and not doped 716 sectors (+f teeth face). An advantage is that the contact switch 704 has substantially no additional friction. The wheels and/or their axis may be supported by means made of electrically insulation material, such as ruby bearing 701.

Referring now to FIG. 7B, the transformation means 115, 715 includes a mechanical collector switch 706. The mechanical collector switch 706 may be in contact with a flexible bent beam or a contact blade 704. In one variant, the mechanical collector switch 706 is rotationally linked to a gear wheel 702.

Referring now to FIGS. 8A to 8D, the transformation means 115, 915 includes a mechanism that moves a mobile element 904 such as an hour hand, which directs a light beam 901 on a specific part of a display or dial 922. The light source 910 is either fixed below the mobile element 904 and the light 901 is directed through the mobile element 904, which acts as a waveguide; or attached to the mobile element 904 so that the emitted light beam 901 moves with the mobile element 904. The light 901 is concentrated on/directed to a specific part of the display or dial 922, and this conveys the information carried by the mechanical source of information of visual information 917 into a luminous representation or visual animation visible to the user/wearer. To enhance the effect of the luminous representation or the visual animation, the light beam 901 can shine on fixed elements 903 on the display or dial 922, such as mirrors, waveguides, diffraction gratings, refractive elements or any optical component common to the industry. Illumination of a portion of the dial 922 on one side of the hand. On one embodiment (shown in FIG. 8A), the light source 910 is fixed and the light 901 is coupled to a mobile waveguide 904. On another embodiment (shown in FIG. 8B), the light source 910 is mobile (mounted on a mobile element 904 such as a hand). On a further embodiment (shown in FIG. 8C), the mobile element 904 guiding the light beam 901 is steered on a set of fixed micromirrors 905 which reflect the light typically 90° toward the elapsed time. The mirrors 905 are also tilted up or down so that the next ones to not shadow the reflected beam 901. The portion of the angle which is illuminated is highlighted by an arc 907. On still another embodiment (shown in FIG. 8D), the light source 910 is coupled into a set of curved waveguides 911. The portion of the angle which is illuminated is highlighted by an arc 907.

Referring now to FIG. 9, the transformation means 115, 1015 includes a phototransistor 1011 or photodiode array 1011 which are switched on/activated simultaneously as a watch hand 1004. The photodiode 1011 is a semiconductor device which converts the light's energy 1001 into an electrical current. On the other hand, the phototransistor 1011 uses the transistor for the conversion of light energy 1001 into an electrical current. The phototransistor 1011 generates current whereas the photodiode 1011 produces both the voltage and current. The light 1001 emitted at the end of the hand 1004 is directed towards an angled or vertical wall of the dial. If the light 1001 coming from the hand 1004 reaches a phototransistor 1011 or photodiode 1011, it is switched on/activated and electrical signal can be dispensed to another light-emitting element or electronical function.

Detection sensitivity/selectivity may be enhanced by having an optional shadowing element 1013 on top of the phototransistor 1011 or photodiode 1011, and/or a bandpass optical filter 1013 corresponding to the light waveguide.

The phototransistor 1011 or photodiode array 1011 is not always ON. It is biased only when the light 1001 in the hand 1004 is ON. ON/OFF cycles could be used in detection mode to lower the power consumption.

Focusing optics could be used to concentrate light 1001 on phototransistor 1011 or photodiode gate 1011.

It is an advantage that there is no physical contact between hand 1004 and switch 1011.

Referring now to FIG. 10A and FIG. 10B, the transformation means 115, 1115 comprises an optical sensor 1111. In this configuration, the mechanical switch (as shown e.g. in FIG. 2A to 2C) between the moving wheel and the electrical contact blade is replaced by an optical switch 1111. Mechanical friction has indeed impact on moment of the rotating element and thus can have influence on the performance and the chronometry of the watch mechanism, in particular of mechanical watch mechanism. Moreover, electrical contacts through moving parts are sensitive to wear. In order to avoid mechanical contact to create electrical connection an optical switch 1111 can used without mechanical influence on the mechanism. A detection light source 1110 is placed on one side of one wheel 1102 of the wheels of the mechanism and the wheel has some opaque or non-transparent 1116 and some transparent portion 1106 (typically holes) at the level of the light source 1110. On the other side of the wheel 1102, an optical detector 1111 sensitive to the wavelength of the detection light source 1110 is place so that to be activated to detect the sequence of opaque/non-transparent 1116 and transparent portions 1106 of the wheel.

Referring now to FIG. 10C, the photodetector 1111 is placed in the same side of the wheel 1102 as the detection light source 1106. Reflective or non-reflective portions 1106 on the wheel allows the light to be redirected to the sensor or simply absorbed or diffused.

Referring now to FIGS. 11A and 11B, the transformation means 115, 1215 includes a reed relay array 1201, close to which a micromagnet 1203 is moved. Alternatively, the micromagnet 1203 could be fixed and the med relay 1201/reed relay array 1201 would be mobile. Instead of the micromagnet 1203, a microcoil 1205 could be switched ON on demand. A moving micromagnet 1203 is moved close to a reed relay array 1201. Either the micromagnet 1203/coil 1205 or the reed relay 1201 can be moved. The micromagnet 1203 can alternatively be realized as a microcoil 1205, the microcoil 1205 being switched ON on demand instead of functioning as a permanent magnet. The advantages of this embodiment are: true ON/OFF, no power consumption, no driving electronic need, and no mechanical friction load on movement. This embodiment may comprise a shielding 1209.

Referring now to FIG. 12, the transformation means 115, 1315 includes a Hall effect sensor array 1307, close to which a micromagnet 1303 is moved. Alternatively, the micromagnet 1303 could be fixed and the Hall effect sensor 1307 would be mobile. Instead of the micromagnet 1303, a microcoil could be switched ON on demand. An advantage of this embodiment is that the magnet 1303 could be smaller compared to the reed relay solution of FIGS. 11A and 11B. The transformation means 1315 may comprise a shielding 1309.

Referring now to FIGS. 13A to 13C, the transformation means 115, 1415 includes a capacitive sensor 1401. Detection based on presence of conductive (e. g. metal) or insulating 1403 (e. g. air) material, or of materials with different permeativities 1405. Differential sensing can be used to enhance sensitivity and ease calibration. Capacitive detection of a moving object 1402 (e. g. a wheel 1402 made typically of a metal 1421). Detection based on presence of conductive (e. g. metal) or insulation 1403 (e. g. air) material, or of materials with different permeativities 1405. Differential sensing can be used to enhance sensitivity and ease calibration. An advantage is the non-contact detection.

Referring now to FIG. 13B, the capacitive senor 1401 is placed on both side of the wheel 1402 and the detection is made by a calculating the difference of capacity depending on the portion of the wheel 1402 which contains portions with different permeativities (through various materials or simply through hollow portions 1411).

Referring now to FIG. 14, the transformation means 115, 1515 includes an absolute position sensing with an encoding with several sensors 1501. By having the moving wheel 1502 with portions of different length over the sensing areas, the signal given by the rotation of the wheel 1502 can interpreted in a univocal position.

The principle of the absolute encoding can be applied to the various sensing method explained in FIGS. 8 to 14.

Referring now to FIG. 15, the transformation means 115, 1915 may include at least one capacitor switch comprising at least one fixed capacitive plate 1980 and at least one mobile capacitive plate 1981 installed on a moving part 1902. At least one of the capacitive plates 1980, 1981 is connected to a light source 1910. The fixed capacitive plate 1980 or the mobile capacitive plate 1981 is activated by an AC source 1901, and depending on the alignment and distance between the capacitive plates 1980, 1981 and the frequency of the AC source 1901, a temporary connection is established between the capacitive plates 1980, 1981, allowing an AC current to flow through the capacitive switch. The shape of the capacitive plates 1980, 1981, the trajectory of the moving part 1902 carrying the mobile capacitive plate 1981, the distance between the capacitive plates 1980, 1981 and the frequency of the AC source 1901 can be selected so as to provide one or more possibilities of establishing the connection, providing different sequences of ON/OFF switching of the capacitive switch. The capacitive switch may be connected so as to power a light source, for example a LED 1910. An advantage of this transformation means is that it can be realized without substantial friction. For example: At 1 kHz of sinus power supply @2 Vrms; 0.1 mA in an LED at 2 Vrms; 20 kOhms of equivalent resistor. C>10*1/(2*pi*20 kOhms*1 kHz)=72 nF. Plate capacitor: 1 mm*1 mm with 50 μm spacing: C=epsilon*A/D=8.85*10\hat{ }−12*1 mm*1 mm/50 μm=0.2 pF.

Referring now to FIGS. 16A and 16B, the transformation means 115, 2115 includes an electric source 2101 and an electrical connection to the hammer 2131 of a traditional ringing mechanism, the hammer being made of conductive material, but insulated 2133 from the watch mechanism. The gong 2103 is made of conductive material, so that when the hammer 2131 hits the gong 2103, a temporary electrical connection between the hammer 2131 and the gong 2103 is made, allowing electrical current to pass. An advantage of this embodiment is that the visual flash (e.g. by means of a light source 2110 such as an LED) is synchronized with the sound. Further, it is possible to realize the light source 2110 in various different colors, as available on the marked.

Referring now to FIGS. 17A to 17D, the transformation means 115, 2215 includes a LED 2210 that flashes and activates selectively a phosphorescent surface 2201 to print the time, for example 6 flashes print 6 dots to show 6 o'clock. Either the LED 2210 or the surface is mobile. By way of example, 3 LEDs 2210 can be used to print hours, quadrants and minutes in parallel. The surface can be a fluorescent liquid moving in a tube 2203. The “lighthouse” configuration as shown in FIG. 8A can be used to move the light on the fluorescent surface. Using the same cam system, the hammer/bell can be replaced by an electric contact to flash the LED. Rather than blinking LED, pre-printed fluorescent dots or numbers may be enlightened, and stopped (mechanically or electrically) on the right dot/number. Even simpler: enlighten only the right dot/number.

Referring now to FIGS. 18A and 18B, the transformation means 115, 2315 includes an electrical logic 2301, such as exemplarily shown in FIGS. 18A and 18B, to generate different electrical connections without using an electronic device. In some cases, it is considered of high value to be able to realize such functionality without using any electronics.

Referring now to FIGS. 19A and 19B, the transformation means 115, 2415 (transforming light beams into an indication such as an image when projected on the window) includes at least one transparent or semi-transparent window 2401. This embodiment can, for example, illuminate a scene 2403 when light is ON 2405 through a transparent or semi-transparent window. This embodiment allows a large was for creativity.

Referring now to FIGS. 20A and 20C, the transformation means 115, 2515 includes laser-drilled pinholes (shown in FIG. 20D) that are invisible to the naked eye, but allow a visible pattern to appear when backlighted by a light source 2510. For enhanced transmission yield, microarrays of lenses could be used to focalize light into holes. This embodiment comprises typically a plate 2511 comprising the laser-drilled pin-holes, at least one light source 2510 which can be one or more LED(s), a PCB/flex PCB 2513 and micro-array lenses 2515. An advantage of this embodiment is that noble material (such as gold or platinum) can be illuminated.

Referring now to FIG. 21, the transformation means 115, 2615 includes a light source 2610 such as an LED lightning (or any other light source (b) mentioned in the present disclosure) at a certain frequency (f2) (such as a pulsed signal 2621, preferably a low frequency typically between 1 Hz and 200 Hz, generated by an energy source 2601) and a watch element moving with a certain periodicity making the oscillation (the oscillation being at a certain frequency f1 near to that of the light source. Typically an escapement has a frequency of 3 Hz or 5 Hz and some electro-mechanical systems which generate light turn at a frequency of 180 Hz) of the element visible to a user/wearer by means of the stroboscopic effect or creating the effect of the zoetrope. A zoetrope is one of several pre-film animation devices that produce the illusion of motion by displaying a sequence of drawings or photographs showing progressive phases of that motion. It was basically a cylindrical variation of the phénakisticope, suggested almost immediately after the stroboscopic discs were introduced.

An advantage of this embodiment is the impressive visual effect. The moving element can be the gong 2603 of a Grande Sonnerie or a minute repeater (“répétition minute”), the escapement (“roue d'ancre” or “échappement”), a tourbillon, a flywheel (“balancier/volant d'inertie”) or any element moving a speed which cannot be perceived by a user/wearer.

In an embodiment, the invention provides an information, a visual animation or a visual presentation to the wearer/user that would otherwise not be visible, for example in poor ambient light conditions or in the dark.

In another embodiment, the invention generates additional esthetical attractivity for carried or worn accessories like watches, jewelry, necklaces, pendants, hats, shoes, handbags, belts etc.

The system and method/apparatus according to this invention provides means to display dynamic information or visual animations in a manner that cannot be easily anticipated by the user/wearer, providing a surprising effect, and is configured to be integrated in an accessory to be worn by a wearer/user such as a piece of apparel, an item of jewelry, a wristwatch, a pocket watch or any other fashion item.

The system and method/apparatus according to this invention includes at least one light source that is hidden, i.e., installed in such a way as to be invisible or integrated so as to be non-identifiable (i.e., camouflaged) as such by the user/wearer when not in use. The light source is one or more light emitting diodes (LED) or any other light producing elements, powered by one or more photovoltaic cells converting ambient light into electricity, by one or more batteries, by one or more electrochemical devices producing electricity, or by one or more micro-generators converting mechanical energy into electricity such as the miniature user-powered lighting device described in application PCT/IB2016/000249 filed on 7 Mar. 2016 by the same applicant, the content of which is explicitly incorporated herein by reference and relied upon to define features for which protection may be sought hereby as it is believed that the entirety thereof contributes to solving the technical problem underlying the invention, some features that may be mentioned hereunder being of particular importance. Optionally the energy to power the light source may be produced in advance and stored until use in one or more energy storage devices such as rechargeable batteries, electrochemical devices, mechanical energy storage arrangements such as springs, spiral springs, spring barrels, or fluids compressed in one or more reservoirs. Where the system includes more than one light source, the light sources may have different sizes and colors, as appropriate for the information/animation to be displayed.

In one embodiment, the system according to this invention provides an indication of an astronomical positioning such as day/night, moon phase, season, etc. in a manner that mimics observable reality and is configured to be integrated in an accessory to be worn by a wearer/user as a piece of apparel, an item of jewelry, a wristwatch, or any other fashion item.

Referring now to FIGS. 22A-22B, the display 3012 of the system of the invention is placed typically on the face of a wrist watch 3010, for example at the 6 o'clock position (FIG. 22A) or at the 3 o'clock position (FIG. 22B), or any other position on a wristwatch face.

Referring now to FIGS. 23A-23B, the display of the system of the invention can be placed so as to be visible when the user/wearer's eye 3122 is facing the face of the wristwatch 3120 (FIG. 23A), but it may as well be constructed so that the user/wearer's eye 3122 can only see the display when viewing it at a certain angle relative to the face of the wristwatch 3120 (FIG. 23B).

Referring now to FIGS. 24A to 24C, a first embodiment of the system 3200 of the invention reproduces the reality by illuminating miniature substantially or partially spherical object 3220 (for example, a representation of the moon such as a spherical shape or a shape including a section of a sphere) with a light source 3230 (for example a LED), the light source 3230 being installed on a rotatable lever 3232 whose rotation axis 3234 is placed near the spherical object 3220 and whose direction is as near as possible to the perpendicular of the observation axis. For example, in order to represent the moon phases, the rotatable lever 3232 makes one turn in 29.53 days, corresponding to the cycle of the moon. In such case, a traditional moon phase mechanism may be used, and an approximation of the 29.53 days cycles may be used, for example 29.5, 30, etc. For a representation of another natural phenomenon, for example the planet Earth as visible from the space station, another period of rotation of the rotatable lever 3232 may be selected. In order to ensure a realistic vision of the illumination of the spherical object 3220, the system 3200 is hidden below a mask 3210, that may be the dial of a wristwatch for example. The field of vision of the observer's eye 3202 is limited by a three dimensional cover 3212, for example representing a telescope, so that the observer can only see a part of the system 3200 through a magnifying lens or a combination of several lenses or a window 3214 (made of a transparent, translucent and/or tunnel-pin-holed opaque material in which the pin-holed surface allows for viewing of an object only from one viewing direction due to their narrow width and great depth). In this way, the ambient environment light has a very limited impact on the spherical object 3220, and the most light illuminating the spherical object 3220 comes from the light source 3230. Since the observer is de facto looking at a three dimensional object 3220, he has the impression of observing the real moon at any time of the day.

When the light source 3200 is on the side with respect to the observation direction, the observer sees half shadowed moon 3243; when the light source 3230 is in front of the moon 3220 and emitting in the direction of observation, the observer sees the full face of the moon illuminated 3244 and when the light source 3230 is behind the moon 3220, an optical mask 3236 prevents the light from being visible by the observer, the observer then seeing a black moon.

In order to emphasize the contrast between shadow and the illuminated part of the moon, the system may be surrounded by light absorbing areas. The moon may also be coated with or formed of light sensitive material.

Referring now to FIGS. 25A and 25B, a second embodiment of the system 3300 provides a two dimensional (flat) display of the illumination with backlighting. A translucent diffusing window 3320 with a representation of the moon is illuminated by a backlight 3330. The backlight 3330 makes the moon appear full. A rotating mask 3332 with two openings 3336 is placed between the light source 3330 and the diffuser 3320 allowing for masking a portion of the translucent window 3320 that represent the unlit part of the moon. The mask 3332 turns according to a rotation speed of 1 turn in 59.06 days representing two moon cycles. The mechanism of the rotating mask relies on a traditional moon phase mechanism 3350 for wrist watches, and may have a slightly different cycle, for example 58, 59, 60 days per cycle.

Referring now to FIGS. 26A and 26B, in the third embodiment of the system 3400, the system 3400 is hidden below a cover 3410 with an opening 3412, and a diffusing window 3420 is placed in or below the opening 3412. The diffusing window 3420 may have engravings or decorations, for example which represent the surface of the moon. A rotating mask 3432 has its axis of rotation 3434 at the center of the system 3400. A light source 3430 (for example one or more LEDs) is located below the rotating mask 3432, and illuminates the diffusing window 3420 from below (relative to the observer's eye). The rotating mask 3432 has an opening 3436 with an appropriate shape so that the clipped part of the light has a shape narrowing the real shadow of the light shadow. The rotating mask 3432 has a rotation speed of one turn in 29.53 days, corresponding to one cycle of the moon.

Referring now to FIGS. 27A to 27C, in the fourth embodiment of the system 3500, the system is hidden below a cover 3510 having a window 3520. The moon image is composed of diffusing light guides 3536. The lightguides 3536 begin at the same point and end at the opposite side of the moon image. They may have a variable width so that they completely fill the entire image. Both sides of the lightguides are arranged so that they present their coupling areas sitting alongside each other and facing two light sources 3530. Two rotating masks 3532 may be positioned so as to obscure some of the lightguides 3536 by rotating around an axis placed under the light sources 3530. The two masks 3532 rotate in opposite directions so that they clip the light in front of the same lightguides 3536 simultaneously. The rotation of the masks 3532 is driven for example by a time keeping mechanism 3550, for example a watch movement so that they make a turn in 59.06 days representing two moon cycles. The resulting display mimics real observation of the moon, for example: full moon 3544, waning gibbous 3545, third quarter 3547, waning crescent 3546.

Referring now to FIGS. 28A to 28C, a fifth embodiment of the system 3600 provides a solution for the indication of the day-night position (day 3660/night 3670) around the globe. It is composed of a three-dimensional representation of the terrestrial globe 3620 made of semi-transparent or translucent material. The globe 3620 is illuminated from inside by a light source 3630 or several light sources emitting in all directions so that the light distribution is substantially homogeneous. The semi-transparent or translucent representation of the terrestrial globe may also be composed of several segments or even of a multitude of pinholes in order to create the semi-transparency. The segments or pinholes may be advantageously distributed with varying densities in different areas to create varying degrees of semi-transparency in these areas, generating different luminosity for these areas when illuminated, for example to emphasize the difference between the continents and the seas. In this configuration, the light source 3630 is fixed. A hemispherical mask 3632 placed inside the globe 3620 and oriented concentrically to the globe blocks the light, darkening half of the globe representing the portion of the earth that is by night 3670. The hemispherical mask 3632 is rotating around its axis collinear to the fixation of the light source 3630. The mask 3632 is driven by a gear 3650 coupled to a time keeping mechanism. The rotation of the mask 3632 makes one turn in 24 hours. The system 3600 can be integrated in a fixed clock, in a pocket watch or in a wrist watch.

Referring now to FIGS. 29A to 29B, in a sixth embodiment of the system 3700, the light source 3730 is not placed at the center of the globe 3720 but is offset and rotates around the central axis. The clipping mask 3732 is placed close to the light source 3730 at a distance so that its shadow darkens half of the globe of the Earth. The rotating mask 3732 and the light source 3730 are rotating at the same speed and make one turn in 24 hours. The clipping mask 3732 can however move up and down along the rotation axis, thanks to a vertical guide 3734. The up and down displacement of the mask 3732 along the axis moves the shadow so that the illuminated hemisphere 3760 makes an angle of up to plus or minus 23° 26′ 12″ with respect to its initial position. An approximation of the 23° 26′ 12″ angle may be used, for example 23° 12′, 23°, etc. The vertical movement of the mask 3732 is controlled by a rotating cam 1136 that makes a turn in one year. The uppermost position of the mask 3732 corresponds to the illumination of the earth globe at the summer solstice 3784 while the lowermost position corresponds to the winter solstice 3788. At the middle position 3782, 3788, the illumination corresponds to the equinoxes. The rotation of the cam 3736 can be controlled by an annual calendar mechanism of a watch or by a perpetual calendar mechanism.

Referring now to FIGS. 30A-30F, the system 7100 of the invention may be used in a wristwatch 7010 to display the date, a “Grande Date”, but also to display any information and/or animation in any accessory to be worn by a wearer/user as a piece of apparel, an item of jewelry, a wristwatch, a pocket watch or any other fashion item, such as date, day, GMT, power reserve, astronomical information, symbol, logo, signs, initials, message, or an artistic image. The information or animation may remain fixed or change dynamically while the display is activated. The system may also take advantage of light color mixing to create the said artistic image.

Referring now to FIG. 30C, the watch dial 7200 is opaque but includes one or several semi-transparent windows 7210. The semi-transparent window 7210 is made of glass, frosted glass, or any other appropriate semi-transparent/translucent material, in an eight embodiment seamlessly integrated in the dial 7200. The dial 7200 and the semi-transparent window 7210 may have similar colors so that the semi-transparent window 7210 is not easy to spot by the user/wearer, preferably dark colors, for example black. The semi-transparent window may also be composed of several segments or even of a multitude of pinholes to create the semi-transparency. The segments or pinholes may be distributed with varying densities in different areas to create varying degrees of semi-transparency in these areas and so generating different luminosity for these areas when illuminated.

Referring now to FIG. 30D, in a ninth embodiment, the watch dial 7202 may present one or several holes 7212 and be completely covered with a layer of semi-transparent material 7222, resulting in an even more inconspicuous semi-transparent window 7220.

Referring now to FIG. 30A, FIG. 30C, FIG. 30D, and FIG. 30E, the watch case 7110 behind the dial 7102, 7202 is opaque so that no ambient light may enter, and as a result, the space behind the semi-transparent window 7210, 7220 is in the dark, and so the objects behind the semi-transparent window 7210, 7220 are invisible to the user/wearer 7020, and the semi-transparent window 7210, 7220 is nearly invisible. A rotating disk 7310 containing the mask 7312 carrying the tens inscriptions 7314 and a rotating disk 7350 containing the mask 7352 carrying the units inscriptions 7354 are installed behind the semi-transparent window 7210, 7220 at an appropriate location so as to present one of their inscriptions 7314, 7354 at a time behind the semi-transparent window 7210, 7220. The at least one light source 7500 is disposed behind the rotating disks 7310, 7350, its main lighting direction pointing towards the semi-transparent window 7210, 7220. The masks 7312, 7352 can be transparent or semi-transparent, can be colored or not, and be made of any appropriate material. The masks 7312, 7352 can also be fixed for constant information or transported by mechanical means other than rotating disks. They can also be positioned behind the semi-transparent window 7210, 7220 with levers, slides, or any mechanical mobilization means. The masks 7312, 7352 may carry any kind of inscriptions for example symbols, logos, artistic images, etc. Of addition, there can be more than 2 masks, and the numbers can represent any indication such as a date, the hour, the minutes, or any other numerical information.

Referring now to FIG. 30B, FIG. 30C, FIG. 30D, and FIG. 30F, when the user/wearer presses the activation button 7050, the at least one light source 7500 is activated, projecting light through the masks 7312, 7352, generating an image 7060 on the semi-transparent window 7210, 7220 which is visible to the user/wearer 7020.

Referring now to FIGS. 31A-31E, the system 7102 of the invention may be used in a wristwatch 7012 as described herein, but also to display any information and/or animation in any accessory to be worn by a wearer/user as a piece of apparel, an item of jewelry, a wristwatch, a pocket watch or any other fashion item, such as date, day, GMT, power reserve, astronomical information, symbols, logo, signs, initials, messages, or an artistic image or images. The information or animation may remain fixed or change dynamically while the display is activated.

Referring now to FIG. 31A, the display of the invention is hidden via camouflaging in and/or on the watch dial, so that when the display is not activated, the user/wearer is not made easily aware of its presence. For example the display may consist of several light sources 7502 which are hidden via being disposed below or by being camouflaged as hours' indexes. In particular, in order to hide the presence of the light sources, the light sources are placed on a transparent substrate and the electrical connections are also transparent. The light source may also be of transparent luminous material layers.

Referring now to FIG. 31B, when the user/wearer pushes the activation button 7052, or as triggered by a program running in the watch 7012, the one or more light sources 7502 of the display are activated according to the information or animation to be displayed, for example lighting or flashing the hours' indexes.

Referring now to FIG. 31C, when the user/wearer pushes the activation button 7052, or as triggered by a program running in the watch 7012, a part of the one or more light sources 7502 of the display are activated according to the information or animation to be displayed, for example lighting or flashing some of the hour indexes in order to indicate a value (in this case in FIG. 31C: 5 light sources are activated) or to animate a scene.

Referring now to FIG. 3D, the tenth embodiment of the system 7102 consists of installing one or more light sources 7502 on a dial 7400, optionally a transparent dial. The dial 7400 can be made of glass, of sapphire or any other transparent or non-transparent material appropriate for the function. The one or more light sources 7502 are installed individually or by groups underneath semi-transparent windows 7230. The semi-transparent window 7230 is made of glass, frosted glass, or any other appropriate semi-transparent material. The semi-transparent window 7230 may be decorated and/or colored so as to look like any traditional decoration or index, the semi-transparent windows can also contain partially transparent elements such as precious stones. Opaque sidewalls 7410 surrounding the light source 7502 ensure that no ambient light may be accidentally reflected in the watch and come back through the semi-transparent window 7230, which could give away its presence. As a result, the light source 7502, when not activated, is nearly invisible for the user/wearer. The electrical power necessary to activate the light source 7502 is transported by transparent conductors built on the dial 7400, so that they are invisible to the user/wearer. The transparent conductors can be made of ITO (indium tin oxide) or any other appropriate transparent conducting material. The transparent conductors may be deposited by traditional microfabrication processes.

Referring now to FIG. 31E, an eleventh embodiment of the system 7102 consists of installing one or more light sources 7502 on a dial 7400, optionally a transparent dial. The dial 7400 can be made of glass, of sapphire or any other transparent or non-transparent material appropriate for the function. The one or more light sources 7502 are installed individually or by groups under opaque screens 7240, so that the light sources 7502 are out of the field of view of the user/wearer. The opaque screens 7240 may be decorated and/or colored so as to look like any traditional decoration or index. When the light sources 7502 are activated, an effect of backlighting of the screens 7240 is obtained. The electrical power necessary to activate the light source 7502 is transported by conductors which are very thin, preferably transparent, built on the dial 7400, so that they are invisible to the user/wearer. The transparent conductors can be made of ITO (indium tin oxide) or any other appropriate transparent conducting material. The transparent conductors may be deposited by traditional microfabrication processes.

Referring now to FIGS. 32A-32E, a twelfth embodiment the system of the invention may be used in a wristwatch 7014 as described here, but also to display any information and/or animation in any accessory to be worn by a wearer/user as a piece of apparel, an item of jewelry, a wristwatch, a pocket watch or any other fashion item, such as date, day, GMT, power reserve, astronomical information, symbols, logo, astronomical constellations, signs, initials, messages, or an artistic image or images. The information or animation may remain fixed or change dynamically while the display is activated.

Referring now to FIG. 32A, in the twelfth embodiment, several light sources are hidden behind one semi-transparent dial 7250 covering the visible area of the wristwatch's face 7024, so that when the display is not activated, no tell-tale feature hints are visible for the user/wearer to recognize that a display may be present. The semi-transparent dial 7250 may be made of any semi-transparent material, may be decorated and/or colored so as to look like any traditional dial, and it may also contain partially transparent elements such as precious stones.

Referring now to FIGS. 32B-32E, when the display is activated, the light produced by the light sources is visible through the semi-transparent dial 7250 and forms an information/animation, such as indicating the time (FIG. 32B), producing an animation (FIG. 32C) and/or displaying symbols, logo, signs, initials, astronomic constellations, messages, or an artistic image or images (FIGS. 32D-32E). The information or animation may remain fixed or change dynamically while the display is activated.

In a thirteenth embodiment, the system 7102 is built using several dials 7400 installed at different heights within the watch, in order to create three dimensional luminous animations or indications.

In a fourteenth embodiment, the system 7100, 7102 includes fixed or mobile mirrors and/or semi-transparent or transparent prisms, generating luminous animations or indications.

In an advantage, the stroboscopic effect of the present embodiment is that it helps visualize the displacement 7641 of the gong 7603 when the gong 7603 is/was activated by the hammer 7631.

In another advantage, the invention provides an information, a visual animation or a visual presentation to the wearer/user that would otherwise not be visible, provoking a surprising effect.

The invention includes the following combined features sets:

1. A display system configured to be integrated in an accessory to be worn by a wearer/user as an article of clothing, an item of jewelry, a wristwatch, a pocket watch or a fashion item, the display system including:
(a) a source of electrical energy,
(b) one or more light sources,
(c) a source of indication selected from one the group of indications consisting of indication of mechanical information, indication of visual animation and indication of a visual presentation,
(d) a transformation device for transforming such information or visual animation into a luminous information or visual animation, and
(e) a control device adapted to allow the user/wearer to control the activation of the system, wherein the system provides a luminous information or visual animation.

2. The display system according to feature set 1, wherein the source of electrical energy is a miniature generator actuated by an energy source selected from one of the group of energy sources consisting of the user/wearer, a battery, an electrochemical device, a rechargeable battery, a solar/photovoltaic cell, and a micro-generator converting mechanical energy into electricity.

3. The display system according to feature set 1, wherein the source of electrical energy is a miniature generator actuated by the combination of the movements of the user/wearer and the effect of gravity on a mobile mass.

4. The display system according to feature sets 2 or 3, wherein the miniature generator is a rotary generator, the mechanical energy provided by the user/wearer is stored in a spring, and the mechanical energy released into the miniature generator through a gear train multiplying the rotation speed of the miniature generator.

5. The display system according to feature set 1, wherein the one or more light sources are selected from one of or a combination of the group of light sources consisting of light bulbs, LECs (light-emitting capacitors), LEDs (light-emitting diodes), OLEDs (organic light-emitting diodes), AMOLEDs (active-matrix organic light-emitting diodes), laser, laser diode, any electroluminescent material activated by a local electric field, any electroluminescent material activated by an electrical current, and phosphorescent material.

6. The display system of feature set 1, wherein the light source is one or more light emitting diodes (LED) or any other light producing elements.

7. The display system according to feature set 1, wherein the source of indication is working continuously.

8. The display system according to feature set 7, wherein the source of indication is a clock movement.

9. The display system according to feature set 1, wherein the source of indication is actuated for the duration of the luminous information or visual animation.

10. The display system according to feature sets 1 or 9, wherein the source of indication is a revolving cylinder or disc including features located at defined locations defining a sequence.

11. A display system according to feature set 1 or 9, wherein the source of mechanical information, is one of the following elements: The mechanical source of information can be taken from a list including hour wheel, minutes wheel, second wheel, center wheel, escape wheel, balance wheel, ratchet wheel, crown or any intermediate gear wheel as well as directly on complication moving part such as:
moon phase indicator wheel;
date indicator;
day of the week indicator;
month indicator,
striking mechanism (hours, quarters, minutes)
1. flywheel;
chronograph mobile;
oscillating weight;
power reserve.

12. A display system according to feature set 1 or 8, wherein the transformation mean is a physical electrical contact.

13. A display system according to feature set Error! Reference source not found. where the contact is created by tracks made of one of the following material: copper, gold, Indium tin oxide (ITO) or any conductive material.

14. A display system according to feature set 1 or 8, wherein the transformation mean is one of the following: an optical sensor, a reed relay, a Hall effect sensor, a capacitive sensor.

15. A display system according to feature set Error! Reference source not found. where the sensor has several sensing area and the source of mechanical information a structure allowing encoded tracks for absolute detection of the position of to create a predefine scheme to the visual animation.

16. The display system according to feature set 1 or 9, wherein the source of indication is the combination of the movements of the user/wearer and the effect of gravity on a mobile mass.

17. The display system according to feature set 1, wherein the transformation device is the combination of one or more electrically conductive tracks and one or more sliders connecting with the one or more conductive tracks.

18. The display system according to feature set 1, wherein the activation means for the user/wearer to control the activation of the system is selected from one of or a combination of the group of activation means consisting of a lever, a push-button, a rotary button, a crown, a rotary crown.

19. The display system according to feature set 1, wherein the source of indication is a clock movement, and after the user/wearer has activated the system, the system is adapted to provide a luminous information or visual animation automatically at predefined time intervals or when the mechanical source of indication reaches a predefined configuration.

20. The display system according to feature set 1 or 14, wherein the source of information indicates the time, the date, the moon phase, the position of the sun.

21. A display system according to feature set 1 or 14, wherein the luminous information, visual animation or visual presentation generate an animation of a scene.

22. The display system of feature set 1, wherein the system includes at least one electrical light source for illuminating the display, the light source optionally being hidden when not activated.

23. The display system of feature set 1, wherein the system displays an astronomical indication or animation and is configured to mimic observable reality.

24. The display system of feature set 1, wherein the energy to power the light source is adapted to be stored so as to enable production and storage in advance until use in one or more energy storage devices selected from one of the group of storage devices consisting of rechargeable batteries, electrochemical devices, mechanical energy storage arrangements such as springs, spiral springs, spring barrels, and fluids compressed in one or more reservoirs.

25. The display system of feature set 1, wherein the light source is hidden from the field of view of the user/wearer behind an opaque screen and is capable of projecting light around the screen, thus generating an animation or an indication.

26. The display system of feature set 1, wherein the light source is mounted on a transparent substrate and the electrical connection is transparent.

27. The display system of feature set 19, wherein the system (3200) is adapted to mimic reality by illuminating miniature substantially or partially spherical object (3220) with a light source (3230), the light source (3230) being installed on a rotatable lever (3232) whose rotation axis (3234) is placed near the spherical object (3220) and whose direction is as near as possible to the perpendicular of the observation axis.

28. The display system of the above feature set, wherein, in order to represent moon phases, the rotatable lever (3232) is adapted to make one turn in substantially 29.53 days, corresponding to the cycle of the moon, in which, preferably, a traditional moon phase mechanism is used.

29. The display system of feature set 22, wherein, in order to ensure a realistic vision of the illumination of the spherical object (3220), the system (3200) is hidden below a mask (3210), such as a dial of a wristwatch.

30. The system of feature set 22, wherein the field of vision of the observer's eye (3202) is limited by a three dimensional cover (3212), optionally representing a telescope, so that the observer can only see a part of the system (3200) through a magnifying lens or a combination of several lenses or a window (3214), so that the ambient light has a very limited impact on the spherical object (3220), and the most light illuminating the spherical object (3220) comes from the light source (3230).

31. The system of feature set 22, wherein in order to emphasize the contrast between shadow and the illuminated part of the spherical object (3220), the system is surrounded by light absorbing areas and the spherical object is coated with or formed of light sensitive material.

32. The system of feature set 1, wherein the system (3300) illuminates a two dimensional (flat) display with a backlight.

33. The system of the above feature set, wherein a translucent diffusing window (3320) with a representation of a spherical object (3220) is illuminated by the backlight (3330) which makes the spherical object appear full.

34. The system of the above feature set, wherein a rotating mask (3332) with two openings (3336) is placed between the light source (3330) and the diffuser (3320) allowing for masking a portion of the translucent window (3320) that represents the unlit part of the spherical object.

35. The system of the above feature set, wherein the mask (3332) is configured to turn at a rotation speed of 1 turn in 59.06 days representing two moon cycles.

36. The system of any one of the above four feature sets, wherein the system (3300) is hidden below a cover (3410) with an opening (3412), and a diffusing window (3420) is placed in or below the opening (3412).

37. The system of any one of the above five feature sets, wherein the diffusing window (3420) of the system (3400) has engravings or decorations, such as representations of the surface of the spherical object represented, and wherein a rotating mask (3432) has its axis of rotation (3434) at the center of the system 3400.

38. The system of the above feature set, wherein a light source (3430) is located below the rotating mask (3432), and illuminates the diffusing window (3420) from below (relative to the observer's eye).

39. The system of the above feature set, wherein the rotating mask (3432) has an opening (3436) with an appropriate shape so that the clipped part of the light has a shape narrowing the real shadow of the light shadow and the rotating mask (3432) has a rotation speed of one turn in 29.53 days, corresponding to one cycle of the moon.

40. A system indicating an astronomical position, the system being configured to mimic observable reality and to be integrated in an accessory to be worn by a wearer/user as a piece of apparel, an item of jewelry, a wristwatch, or any other fashion item, the system (7100) having a watch dial (7200) which is opaque but includes one or several semi-transparent windows made of glass, frosted glass, or any other appropriate semi-transparent/translucent material, integrated in the dial (7200).

41. The system of the above feature set, wherein the semi-transparent material is composed of several segments or of a multitude of pinholes to create the semi-transparency.

42. The system of the above feature set, wherein the segments or pinholes are distributed with varying densities in different areas to create varying degrees of semi-transparency in these areas and so generating different luminosity for these areas when illuminated

43. The system of the penultimate feature set, wherein the watch dial (7202) presents one or several holes (7212) and be completely covered with a layer of semi-transparent material (7222), resulting in an even more inconspicuous semi-transparent window (7220).

44. The system of any one of feature sets 40 to 43, wherein the system comprises at least one rotating disk (7310), the at least one rotating disk (7310) comprising at least one mask (7312, 7352), the mask (7312, 7352) being disposed behind the semi-transparent window (7210, 7220).

45. The system of the above feature set, wherein the at least one mask (7312, 7352) comprises unit inscriptions (7314) selected from one of the group of unit inscriptions consisting of time-related information (such as year, month, date, hour, minutes, seconds, phase of the moon) and non-time numerical information (such as altitude, speed, geographic direction, temperature).

46. The system of feature set 1, wherein the system is a wristwatch, wherein the system is placed on the face of the wristwatch preferably at the 6 o'clock position or at the 3 o'clock position.

47. The wristwatch of the above feature set, wherein the display of the system of the invention is placed so as to be visible when the user/wearer's eye (22) is facing the face of the wristwatch (20).

48. The wristwatch of the penultimate feature set, wherein the system of the invention is constructed so that the user/wearer's eye (3122) can only see the display when viewing it at a certain angle relative to the face of the wristwatch (3120).

49. The system of feature set 1, wherein the light source is hidden behind a semi-transparent window in an otherwise opaque chamber and projects light through the semi-transparent window, so that the light is visible for the user/wearer, thus generating an animation or an indication.

50. The system of feature set 1, wherein the light source is hidden behind a semi-transparent window in an otherwise opaque chamber and projects light through a mask wearing at least one inscription on the semi-transparent window, so that the inscription is visible for the user/wearer on his side of the semi-transparent window, thus generating an animation or an indication.

51. The system of any of feature sets 1 to 39, wherein the source of indication is an indication of mechanical information and upon activation through the user/wearer with the mechanical source of information, the luminous information or visual animation is activated.

52. The system of feature set 51, wherein the luminous information or visual animation is activated substantially immediately upon the activation of the mechanical source through the user/wearer.

53. The system of feature set 1, wherein the source of indication is an indication of mechanical information, luminous information or visual animation, wherein upon the activation of the mechanical source through the user/wearer, the luminous information or visual animation is activated after a time delay after the activation through the user/wearer with the mechanical source, the time delay being defined by the mechanical source.

54. The system of feature set 51, wherein the luminous information or visual animation is activated when the following two conditions are fulfilled:
upon the activation of the mechanical source through the user/wearer; and
when the mechanical source is in a pre-determined configuration such as “top of the hour”, “quarter of an hour” or “noon”.

It should be appreciated that the particular implementations shown and herein described are representative of the invention and its best mode and are not intended to limit the scope of the present invention in any way.

It should be appreciated that many applications of the present invention may be formulated. Moreover, the system contemplates the use, sale and/or distribution of any goods, services or information having similar functionality described herein.

As will be appreciated by skilled artisans, the present invention may be embodied as a system, a device, or a method.

The present invention is described herein with reference to block diagrams, devices, components, and modules, according to various aspects of the invention. It will be understood that each functional block of the block diagrams, and combinations of functional blocks in the block diagrams, can be implemented.

Accordingly, the block diagram illustrations support combinations of means for performing the specified functions, combinations of steps for performing the specified functions, and program instruction means for performing the specified functions. Each functional block of the block diagrams and flowchart illustrations, and combinations of functional blocks in the block diagrams, may be implemented by either special purpose hardware-based computer systems which perform the specified functions or steps, or suitable combinations thereof.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that includes a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

1. A display system configured to be integrated in an accessory to be worn by a wearer/user as an article of clothing, an item of jewelry, a wristwatch, a pocket watch or a fashion item, the display system including:
(a) a source of electrical energy,
(b) one or more light sources,
(c) a source of mechanically generated information, the mechanically generated information being variable, wherein the system is adapted to indicate the mechanically generated information via an indication selected from one of the group of indications consisting of indication of mechanical information, indication of visual animation and indication of a visual presentation,
(d) a transformation device adapted for transforming such mechanically generated information into luminous information or visual animation, and the source of electrical energy adapted to feed electrical energy to the one or more light sources indirectly via the transformation device,
(e) a control device adapted to allow the user/wearer to control the activation of the system, wherein the system provides a luminous information or visual animation, and
the source of electrical energy being
a miniature generator actuated by the combination of the movements of the user/wearer and the effect of gravity on a mobile mass, or
an energy source selected from one of the group of energy sources consisting of the user/wearer, a battery, an electrochemical device, a rechargeable battery, a solar/photovoltaic cell, and a micro-generator converting mechanical energy into electricity.

2. (canceled)

3. (canceled)

4. The display system according to claim 1, wherein the miniature generator is a rotary generator, the mechanical energy provided by the user/wearer is stored in a spring, and the mechanical energy released into the miniature generator through a gear train multiplying the rotation speed of the miniature generator.

5. The display system according to claim 1, wherein the one or more light sources are selected from one of or a combination of the group of light sources consisting of light bulbs, LECs (light-emitting capacitors), LEDs (light-emitting diodes), OLEDs (organic light-emitting diodes), AMOLEDs (active-matrix organic light-emitting diodes), laser, laser diode, any electroluminescent material activated by a local electric field, any electroluminescent material activated by an electrical current, and phosphorescent material.

6. The display system of claim 1, wherein the light source is one or more light emitting diodes (LED) or any other light producing elements.

7. The display system according to claim 1, wherein the indication is working continuously.

8. The display system according to claim 7, wherein the indication is a clock movement.

9. The display system according to claim 1, wherein the indication is actuated for the duration of the luminous information or visual animation.

10. The display system according to claim 1, wherein the indication is a revolving cylinder or disc including features located at defined locations defining a sequence.

11. (canceled)

12. A display system according to claim 1, wherein the transformation device is a physical electrical contact.

13. A display system according to claim 12 where the contact is created by tracks made of one of the following material: copper, gold, Indium tin oxide (ITO) or any conductive material.

14. A display system according to claim 1, wherein the transformation device is one of the following: an optical sensor, a reed relay, a Hall effect sensor, a capacitive sensor.

15. A display system according to claim 14 where the sensor has several sensing area and the source of mechanical information a structure allowing encoded tracks for absolute detection of the position of to create a predefine scheme to the visual animation.

16. The display system according to claim 1, wherein the indication is the combination of the movements of the user/wearer and the effect of gravity on a mobile mass.

17. The display system according to claim 1, wherein the transformation device is the combination of one or more electrically conductive tracks and one or more sliders connecting with the one or more conductive tracks.

18. The display system according to claim 1, wherein an activation means for the user/wearer to control the activation of the system is selected from one of or a combination of the group of activation means consisting of a lever, a push-button, a rotary button, a crown, a rotary crown.

19. The display system according to claim 1, wherein the indication is a clock movement, and after the user/wearer has activated the system, the system is adapted to provide a luminous information or visual animation automatically at predefined time intervals or when the mechanical source of indication reaches a predefined configuration.

20. (canceled)

21. A display system according to claim 1, wherein the luminous information, visual animation or visual presentation generate an animation of a scene.

22. The display system of claim 1, wherein the system includes at least one electrical light source for illuminating the display, the light source optionally being hidden when not activated.

24. The display system of claim 1, wherein the energy to power the light source is adapted to be stored so as to enable production and storage in advance until use in one or more energy storage devices selected from one of the group of storage devices consisting of rechargeable batteries, electrochemical devices, mechanical energy storage arrangements such as springs, spiral springs, spring barrels, and fluids compressed in one or more reservoirs.

25. The display system of claim 1, wherein the light source is hidden from the field of view of the user/wearer behind an opaque screen and is capable of projecting light around the screen, thus generating an animation or an indication.

26. The display system of claim 1, wherein the light source is mounted on a transparent substrate and an electrical connection is transparent.

27.-45. (canceled)

46. The display system of claim 1, wherein the system is placed on the face of the wristwatch preferably at the 6 o'clock position or at the 3 o'clock position.

47. The display system of the above claim, wherein the display of the system of the invention is placed so as to be visible when the user/wearer's eye (22) is facing the face of the wristwatch (20).

48. The display system of the penultimate claim, wherein the system of the invention is constructed so that the user/wearer's eye (3122) can only see the display when viewing it at a certain angle relative to the face of the wristwatch (3120).

49. The display system of claim 1, wherein the at least one light source is hidden behind a semi-transparent window in an otherwise opaque chamber and projects light through the semi-transparent window, so that the light is visible for the user/wearer, thus generating an animation or an indication.

50. The display system of claim 1, wherein the light source is hidden behind a semi-transparent window in an otherwise opaque chamber and projects light through a mask wearing at least one inscription on the semi-transparent window, so that the inscription is visible for the user/wearer on his side of the semi-transparent window, thus generating an animation or an indication.

51. The system of claim 1, wherein the indication is an indication of mechanical information and upon activation through the user/wearer with the mechanical source of information, the luminous information or visual animation is activated.

52. The display system of claim 51, wherein the luminous information or visual animation is activated substantially immediately upon the activation of the mechanical source through the user/wearer.

53. The display system of claim 1, wherein the indication is an indication of mechanical information, luminous information or visual animation, wherein upon the activation of the mechanical source through the user/wearer, the luminous information or visual animation is activated after a time delay after the activation through the user/wearer with the mechanical source, the time delay being defined by the mechanical source.

54. The system of claim 51, wherein the luminous information or visual animation is activated when the following two conditions are fulfilled:
upon the activation of the mechanical source through the user/wearer; and
when the mechanical source of information is in a pre-determined configuration such as “top of the hour”, “quarter of an hour” or “noon”.
